(19) United States
(12) Patent Application Publication
(10) Pub. No.: US 2019/0073213 A1
(43) Pub. Date: Mar. 7, 2019

(54) SENDING UPDATES ASSOCIATED WITH A TRANSACTION PLATFORM TO A DISTRIBUTION GROUP OF USERS ASSOCIATED WITH A MESSAGING SERVICE

(71) Applicant: Alibaba Group Holding Limited, George Town (KY)

(72) Inventors: Guangqian Dong, Hangzhou (CN); Zhiyan Liu, Hangzhou (CN); Shuying Su, Hangzhou (CN); Zhenhao Wu, Hangzhou (CN)

(21) Appl. No.: 16/116,517

(22) Filed: Aug. 29, 2018

(30) Foreign Application Priority Data
Sep. 4, 2017 (CN) 201710787118.7

(51) Int. Cl. G06F 8/65; H04L 29/08; H04L 12/58

(52) U.S. Cl. CPC G06F 8/65; H04L 67/34; H04L 51/046; H04L 67/18; H04L 67/30; H04L 67/26; H04L 67/1044

(57) ABSTRACT

Sending updates associated with a transaction platform to a distribution group of users associated with a messaging service is disclosed, including: receiving an indication of an update associated with a store associated with a transaction platform from a server associated with the transaction platform; in response to the indication, identifying a distribution group of one or more users associated with a messaging service and wherein the distribution group has a binding relationship to the store; determining respective one or more devices corresponding to the one or more users of the distribution group; and sending the update to the respective one or more devices, wherein the update is configured to be displayed within a respective messaging application executing at each of the respective one or more devices.

### CROSS REFERENCE TO OTHER APPLICATIONS

This application claims priority to People's Republic of China Patent Application No. 201710787118.7 entitled COMMUNICATION METHOD AND INFORMATION SHARING METHOD AND MEANS, filed Sep. 4, 2017 which is incorporated herein by reference for all purposes.

### FIELD OF THE INVENTION

The present application relates to a field of communication technology. In particular, the present application relates to techniques related to sending messages from a transaction platform to a distribution group of users at a messaging service.

### BACKGROUND OF THE INVENTION

In the related art, mobile organization office platforms are being applied to the office work processes of an ever wider array of enterprises, educational institutions, government agencies, and various other organizations. Not only can mobile organization office platforms increase the efficiency of inter-user communication and lower communication costs, but they can also effectively increase users' event handling and office work efficiency.

### BRIEF DESCRIPTION OF THE DRAWINGS

Various embodiments of the invention are disclosed in the following detailed description and the accompanying drawings.

FIG. 1 is a diagram of an embodiment of a system for sending updates associated with a transaction platform to a distribution group of users associated with a messaging service.

FIG. 2 is a flow diagram showing an embodiment of a process for sending updates associated with a transaction platform to a distribution group of users associated with a messaging service.

FIG. 3 is a flow diagram showing an embodiment of a process for presenting an update associated with a transaction platform within a messaging application.

FIG. 4 is a flow diagram showing an embodiment of a process for creating a distribution group associated with an organization.

FIG. 5 is a flow diagram showing an embodiment of a process for binding a distribution group associated with a messaging service to a store associated with a transaction platform.

FIG. 6 is a flow diagram showing an embodiment of a process for sending updates associated with a transaction platform to a distribution group of users associated with a messaging service.

FIG. 7 is a flow diagram showing an embodiment of a process for presenting an update associated with a store within a messaging application.

FIG. 8 is a flow diagram showing an embodiment of a process for sending updates associated with a platform to a distribution group of users associated with a messaging service.

FIG. 9 is a flow diagram showing an embodiment of a process for presenting an update associated with a server within a messaging application.

FIG. 10 is a diagram of an example function guide interface at a website or application associated with the transaction platform.

FIG. 11 is a diagram of an example messaging application interface for sending a binding request to bind an organization that is recognized by the messaging service to a store of the transaction platform.

FIG. 12 is a diagram of an example messaging application interface associated with starting the Cloud Operational Command Center.

FIG. 13 is a diagram of an example messaging application interface associated with logging into an account at the messaging service.

FIG. 14 is a diagram of an example messaging application interface associated with initiating the launch of the Cloud Operational Command Center.

FIG. 15 is a diagram of an example messaging application interface for binding an organization to a store of the transaction platform.

FIG. 16 is a diagram of an example messaging application interface for confirming the binding of an organization to a store of the transaction platform.

FIG. 17 is a diagram of an example messaging application interface for selection confirmation.

FIG. 18 is a diagram of an example messaging application interface for a no authorization prompt.

FIG. 19 is a diagram of an example messaging application interface for a user associated with the manager/administrator role with respect to the store.

FIG. 20 is a diagram of an example messaging application interface for the user associated with the manager/administrator role with respect to the store.

FIG. 21 is a diagram of an example messaging application interface for the Cloud Operational Command Center.

FIG. 22 is a diagram of an example messaging application interface for adding information associated with staff members of a store at the messaging service.

FIG. 23 is a diagram of an example messaging application interface for adding a core staff member.

FIG. 24 is a diagram of an example messaging application interface for a chat list.

FIG. 25 is a diagram of an example messaging application interface for a chat interface.

FIG. 26 is a diagram of an example messaging application interface for a chat interface.

FIG. 27 is a diagram of an example floating display window for presenting application functions in a chat interface at a messaging application.

FIG. 28 is a diagram of an example floating display window for presenting application functions in a chat interface at a messaging application.

FIG. 29 is a diagram of an example messaging application interface for an organization.

FIG. 30 is a diagram of an example messaging application interface for a user associated with the manager/administrator role at the store.

FIG. 31 is a diagram of an example messaging application interface for a distribution group member that is automatically being reminded.

FIG. 32 is a functional diagram illustrating an embodiment of a programmed computer system for sending updates associated with a transaction platform to a distribution group of users associated with a messaging service.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of sending updates associated with a transaction platform to a distribution group of users associated with a messaging service are described herein. An indication of an update associated with a store associated with a transaction platform is received from a server associated with the transaction platform. For example, the update may include a real-time update associated with the current inventory associated with the store, the current number of users that are browsing products associated with the store, or any other dynamic or static attribute associated with the store at the transaction platform. In response to the indication, a distribution group of one or more users associated with a messaging service and where the distribution group has a binding relationship to the store is identified. Prior to receiving indication of the update, a distribution group of users that have accounts with a messaging service is requested to have a binding relationship with the store such that the distribution group members are to receive updates with respect to the store within their respective messaging applications executing at their respective devices. Respective one or more devices corresponding to the one or more users of the distribution group are determined. The update is sent to the respective one or more devices. The update is configured to be displayed within a respective messaging application executing at each of the respective one or more devices.

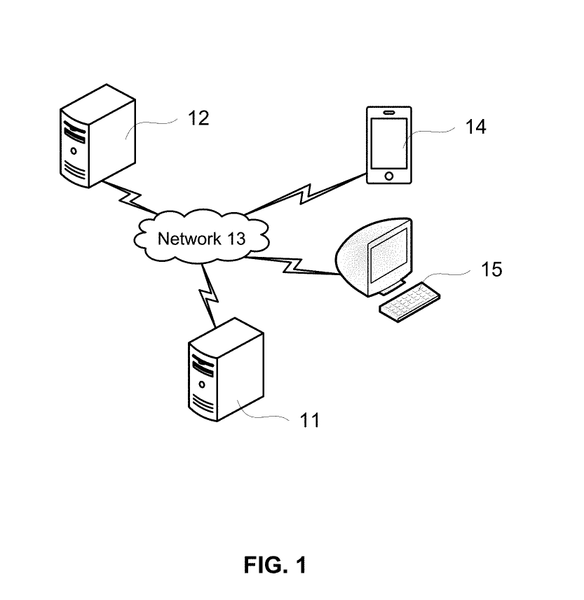

FIG. 1 is a diagram of an embodiment of a system for sending updates associated with a transaction platform to a distribution group of users associated with a messaging service. As shown in FIG. 1, the system comprises first server 11, second server 12, network 13, and various electronic devices such as mobile device 14 and computer 15.

In some embodiments, first server 11 and second server 12 are physical servers comprising an independent host computer. In some embodiments, first server 11 and second server 12 are virtual servers carried on a host computer group. In some embodiments, first server 11 and second server 12 are cloud servers.

In various embodiments, first server 11 is configured to implement a transaction platform. In various embodiments, a transaction platform comprises a platform that comprises multiple online stores where each store comprises various products or services that are for sale. In various embodiments, the transaction platform facilitates purchases and payments for the products at each of its online stores. For example, different stores associated with the transaction platform may be managed by different users.

Second server 12 is configured to implement one or more services related to a mobile organization office platform. In various embodiments, the mobile organization office platform includes a messaging service. For example, examples of the messaging service include enterprise instant messaging (ELM) such as Skype For Business®, Microsoft Teams®, Yammer®, Workplace®, Slack®, Enterprise WeChat®, FXiaoKe®, E-Fetion®, and Qiye Yixin®. In various embodiments, the messaging service comprises a service in which users create accounts and are able to send chat messages to each other using a corresponding messaging application that is executing on the users' respective devices such as mobile device 14 and computer 15, for example. For example, the messaging service is configured to store for each user account, the identifying information (e.g., name, address, phone number of the registered phone) associated with the corresponding user and also at least some identifying information associated with other users that are contacts of the former user at the messaging service. Other than the messaging service, the mobile organization office platform may also be configured to serve as an integrated function platform for various other functions such as, for example, handling review and approval events (e.g., requests for time off, requests for office supplies, and financial review and approval events), attendance-checking events, task events, logging events, and other internal organization events; or handling events external to the organization such as ordering meals or purchasing. Various embodiments described herein do not impose restrictions on the functions that are configured to be performed by the mobile organization platform.

Mobile device 14 and computer 15 are two example devices that are configured to communicate with at least one of first server 11 and second server 12. Other examples of devices that may be configured to communicate with at least one of first server 11 and second server 12 include tablet devices, notebook computers, palmtop computers (personal digital assistants, PDAs), and wearable devices (such as smart glasses or smart watches). Various embodiments described herein do not impose restrictions on the type of devices that may be configured to communicate with at least one of first server 11 and second server 12. In various embodiments, each of mobile device 14 and computer 15 is configured to communicate with at least one of first server 11 and second server 12 using one or more locally executing client applications. For example, each of mobile device 14 and computer 15 is configured to communicate with first server 11 using an application associated with the transaction platform and each of mobile device 14 and computer 15 is configured to communicate with second server 12 using an application associated with the mobile organization office platform and where the application is configured to implement messaging capabilities. In some embodiments, a client application executing at a device such as mobile device 14 or computer 15 may include a web browser that has accessed a webpage (e.g., one that is based on HTML5 technology) related to the transaction platform or an application that is separate from the web browser.

Network 13, over which first server 11, second server 12, mobile device 14, and computer 15 interact with each other, may include multiple types of wired or wireless networks. In some embodiments, network 13 may include a public switched telephone network (PSTN) and the Internet. For example, a private chat message may be established between users of any two electronic devices over network 13. In various embodiments, multiple users using respective devices may take part in the same distribution group and in group chats corresponding to the distribution group, with the result that any user can send communication messages through their own electronic device to all other users in the group chat and thus achieve fast and convenient group communications.

In various embodiments, a user using a device, such as one of mobile device 14 or computer 15, sends a binding request using a messaging application executing at mobile device 14 or computer 15 to a messaging service implemented by second server 12 to create a binding relationship between an online store that is recognized by a transaction platform implemented by first server 11 and a distribution group of users on the messaging service that is implemented by second server 12. In some embodiments, a distribution group is identified by a corresponding name and/or the users that form its members. In some embodiments, the distribution group comprises one or more users (including the requesting user) who all have messaging accounts with the messaging service. In some embodiments, the binding request includes identifying information associated with the store, identifying information associated with the distribution group, and identifying information associated with the requesting user. In response to the binding request, second server 12 is configured to forward the request to first server 11 for first server 11 to determine whether the requesting user is associated with a management/administrator role with respect to the store. For example, first server 11 is configured to check whether the requesting user is associated with a management/administrator role with respect to the store by comparing the identifying information associated with the requesting user to stored user information associated with different roles/positions within the store. Second server 12 is configured to receive a response to the binding request from first server 11. In the event that the response indicates that the requesting user does have a management/administrator role with respect to the store, second server 12 is configured to store a binding relationship between the distribution group and the store and also enables subsequent updates associated with the store to be pushed to devices of users that are included in the distribution group within the respective messaging application of each user member of the distribution group.

In some embodiments, a distribution group may be created before or after the requesting user sends a binding request to second server 12. For example, the distribution group may be created by a user of a device (e.g., either mobile device 14 or computer 15) sending a request to create a distribution group through a locally executing messaging application. For example, the distribution group is created by at least a provided distribution group name and also at least one user of the messaging service that is to be a member of the distribution group. The membership of the distribution group may be edited to add or remove users.

As activity updates (e.g., inventory changes, the number of users browsing, the total value of transactions made) with respect to the store at the transaction platform are generated at first server 11, first server 11 is configured to send such updates to the messaging server that is implemented by second server 12. In response to a received update, second server 12 is configured to identify the distribution group that has a binding relationship to the store. Second server 12 then determines information associated with the device that is used by each user within the distribution group and then pushes the store update to each such device (e.g., mobile device 14 and computer 15). When a user of the distribution group opens the messaging application executing at his or her device, the update is presented within a group chat interface within the messaging application, where the users of the distribution group may also send messages to the entire distribution group within the group chat interface. As such, not only can users of the distribution group all view the same updates that were generated at the transaction platform, but they can continue to send each other messages within the same group chat interface/window.

For example, an employee/owner of a store at a transaction platform may create a distribution group with a messaging service that includes other employees of the store. One of such users may then send a binding request to bind the distribution group to the store. After doing so, updates with respect to the store that are generated by the transaction platform that is implemented by first server 11 may be sent to the messaging service that is implemented by second server 12 and then in turn, pushed by second server 12 to the device of each user that is included in the distribution group. In various embodiments, the updates are presented at each device within a group chat interface within the messaging application executing at the device.

For example, during periods in which frequent, dynamic updates are expected from an online store, such as during special promotional events (e.g., Black Friday or Double Eleven day), real-time updates regarding the inventory of products and/or user activity at the online store may be desirable to users that are associated with managing/operating the store. By enabling such updates to be automatically forwarded to the devices of such users and presented within their messaging applications, the users associated with operating the store can be kept apprised of the dynamic situation regarding their store and also have an opportunity to communicate to each other within the same messaging application or even same group chat window. Furthermore, presenting store updates within a group chat window within a messaging application at a user's device allows the user to receive real-time store activity information within a group chat context without needing to leave the messaging application to check a separate window/application to check on the current status of the store. By being able to view store-related updates directly in a messaging application, a user is spared the hassle of needing to switch to a different application (e.g., associated with the transaction platform or a web browser) to log in to the transaction platform to directly monitor the contents of the relevant store at the transaction platform.

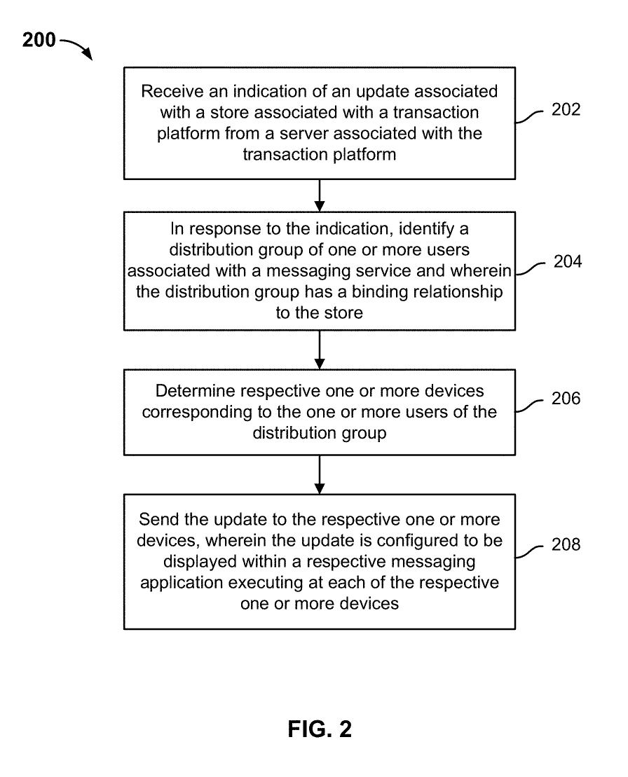

FIG. 2 is a flow diagram showing an embodiment of a process for sending updates associated with a transaction platform to a distribution group of users associated with a messaging service. In some embodiments, process 200 is implemented, at least in part, at second server 12 of FIG. 1.

At 202, an indication of an update associated with a store associated with a transaction platform is received.

In various embodiments, the transaction platform facilitates network-based online transaction operations between seller users and buyer users. Sellers set up stores on the transaction platform and submit information about store merchandise to the transaction platform. Buyers may view the seller-submitted information about available merchandise via the transaction platform and perform transactions concerning the merchandise at the platform.

In various embodiments, the update associated with the store includes store activity data and/or activity data associated with the transaction platform of which the store was a part. Examples of updates include at least one or more of the following: an announcement message issued by the transaction platform, statistical data on transactions of the store (e.g., detailed, serially recorded statements, all transaction data for the entire store, partial transaction data of the store), and statistical data on transactions of the transaction platform (e.g., detailed, serially recorded statements, all transaction data for the entire network transaction platform, partial transaction data of the network transaction platform).

In some embodiments, the update may include real-time data. That is, data may be sent to the corresponding distribution group immediately after it is generated. For example, there is no configured/intentional delay with regard to pushing a real-time update from the transaction platform to the distribution group; there are only delays caused by objective factors such as network factors and device performance. In some embodiments, the information may comprise statistical data. For example, all the data generated within a specific interval of time is collected and is sent to the distribution group after it is processed into an appropriate statistical form. As a result, the statistical data will involve time sequence-related delays. However, it can, to a certain degree, express overall data conditions and trends.

At 204, in response to the indication, a distribution group of one or more users associated with a messaging service is identified and wherein the distribution group has a binding relationship to the store.

In various embodiments, a server that is configured to implement the messaging service stores established binding relationships between distribution groups of users of the messaging service and stores of a transaction platform (e.g., that is implemented by a separate server). In response to the received indication of the update, the distribution group that has a stored binding relationship to the store that is identified by the indication is determined.

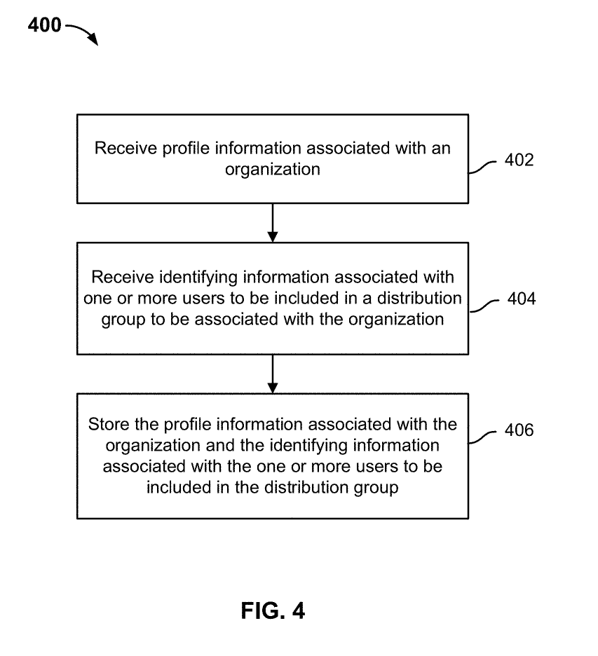

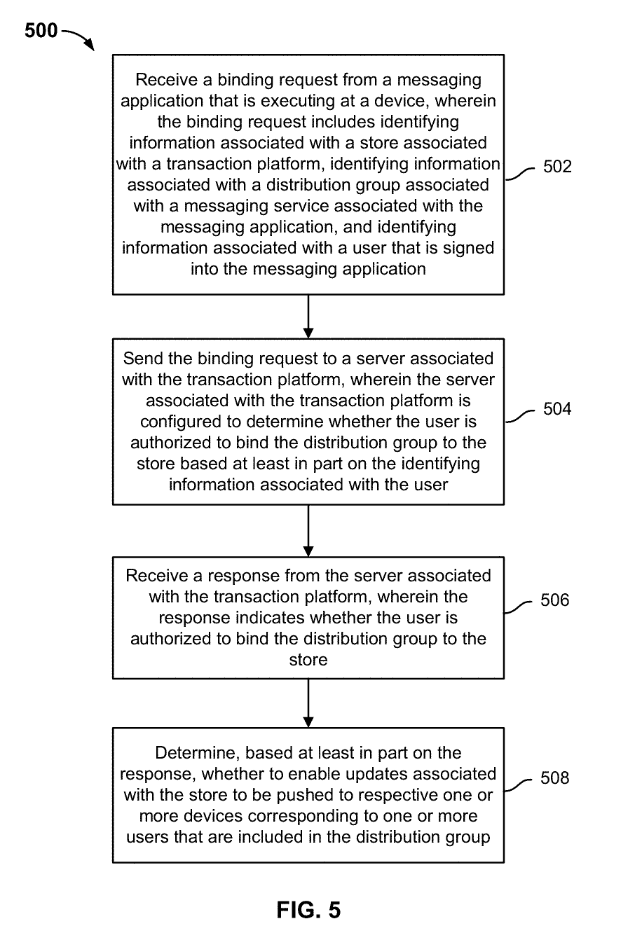

In some embodiments, prior to process 200, a binding relationship has already been established between the store of the transaction platform and a distribution group that is recognized by the messaging service. In various embodiments, a distribution group comprises one or more users that have registered accounts with the messaging service. In some embodiments, a distribution group is created by a user sending a request to create the distribution group from a messaging application executing at a device to a server associated with implementing the messaging service and subsequently submitting information regarding the group or the users therein. FIG. 4 describes one example process of creating a distribution group of users. In some embodiments, a distribution group has a binding relationship to a store of the transaction platform as a result of a user from a distribution group sending a binding request from a messaging application executing at a device to a server associated with implementing the messaging service. In some embodiments, it is determined whether the user and/or the device used by the user who had sent the binding request is associated with an administrator and/or management role (e.g., a store manager) with respect to the store. If it is determined that the user who had sent the binding request is associated with an administrator and/or management role with respect to the store (e.g., by the server associated with implementing the transaction platform comparing identifying information associated with the user against stored identifying information regarding users and their various roles/positions with respect to the store), the binding request is granted and a binding relationship is stored between the store and the distribution group. FIG. 5 describes one example process of creating a binding relationship between a store associated with a transaction platform and a distribution group associated with a messaging service. Even without having a binding relationship to the store, users within the distribution group may be able to communicate to each other within a group chat window/interface that is presented within the messaging application executing on each user's device. However, by virtue of the distribution group having a binding relationship to the store, updates with respect to the store are sent by the transaction platform to the messaging service and the messaging service pushes the updates to the devices of each user within the distribution group, such that the updates are presented within a group chat window in which users of the distribution group can also send messages to each other.

In some embodiments, an organization is created with the messaging service, where the organization is an entity that is recognized by the messaging service. For example, the organization may comprise a group of users (e.g., that work for a particular enterprise) of the messaging service and also metadata associated with the organization (e.g., organization name) and each user (e.g., name, device information, a corresponding position with the store). In some embodiments, at least some of the members of the organization can be added to a distribution group of users. As such, in some embodiments, a binding request is sent by a user using a messaging application to the messaging service to bind a store of the transaction platform to the organization and therefore the distribution group of users associated with that organization. The distribution group of users would in turn have a binding relationship with the store. For example, the users that are added to the distribution group may comprise members of the organization/store. For example, this organization may have been established prior to binding the store to the organization or the organization may be created at the time the binding request is sent to the messaging service. For example, the name of this organization may be the same as or similar to the name of the store, and consequently the messaging service may be able to automatically relate the two to each other. Or the messaging service may give priority in recommending the organization to the messaging service's relevant user (e.g., the person in charge of the store, the store manager, etc.). By binding a store to an organization, information maintained by the messaging service on the members within the organization may be reused. For example, information on the organization members may be conveniently introduced into the distribution group to form the membership of the distribution group without the need to manually add users one at a time. User operations can be greatly simplified in this way. However, in some other embodiments, the store may be unrelated to an organization.

In some embodiments, the distribution group members include the owner/staff/employees of the store of the transaction platform. For example, the distribution group may include users that are registered users of the messaging service if not also a registered user/administrator of the store of the transaction platform.

In some embodiments, a user of the transaction platform that is registered as the manager/administrator of the store may submit to the transaction platform identifying information of the staff members of the store. For example, identifying information of the staff members of the store includes each staff member's name and position within the store (e.g., personnel that is in charge of customer service for the store, personnel that is in charge of the enterprise that produces the merchandise for the store, sales personnel, and personnel that is assigned to process returns to the store) on the transaction platform. In some embodiments, new information about the staff (e.g., names of new staff members and their positions or names of ex-staff members and their former positions) may be synchronized from the transaction platform to the messaging service without the need for the same information to be submitted to the messaging service with respect to the organization/distribution group to which the store was previously bound. After determining the distribution group associated with the transaction platform, the store manager may still assign store staff members through the transaction platform, such changes in staffing may be synchronized to the messaging service and the messaging service may update the members of the bound distribution group by, for example, automatically adding new staff to and automatically removing deleted staff from the distribution group.

In some embodiments, a user (e.g. with the manager/administrator role with respect to the store and for which such a position is also stored by the messaging service) may add the store's staff members to the distribution group at the messaging service by searching a directory of the messaging service for registered users of the messaging service based on the staff members' contact numbers, email addresses, associated organizations, and friend relationships with other users and selecting the found users to be included in a certain distribution group that is bound to a store. In some embodiments, if a staff member cannot be found within the directory of the messaging service, then it is assumed that the staff member is not a registered user of the messaging service. In such an event, the staff member's contact information (e.g., phone number or email address) is submitted to the messaging service and the messaging service is configured to send a registration prompt to the staff member using their contact information. Thereupon, after the staff member registers an account with the messaging service, the staff member may be added to the distribution group that is bound to the store with which the staff member is associated.

In some embodiments, the users other than the staff members of the store may be added into the distribution group. Other users such as, for example, vendors, distributors, customer service personnel of the transaction platform, and customer service of the messaging service may also be added by the user with the manager/administrator role with respect to the store.

At 206, respective one or more devices corresponding to the one or more users of the distribution group are determined.

Device information (e.g., phone number, hardware information, MAC address, or other identifying information) associated with each distribution group member is stored. For example, such information was collected when the user was registering for an account with the messaging service.

At 208, the update associated with the store is sent to the respective one or more devices, wherein the update is configured to be displayed within a respective messaging application at each of the respective one or more devices.

In various embodiments, device information associated with each member of the identified distribution group is used to send the update associated with the store to the device of each member of the distribution group. The update information is then presented at each device (e.g., with a corresponding timestamp) within a group chat interface/window of the messaging application executing at the device and where the group chat interface/window is viewable to all members of the distribution group. For example, the update may appear as a message within the group chat interface/window that is submitted to the group by a group member but one that is assigned a name/handle that is associated with a computerized assistant (e.g., a chatbot). In another example, the update may appear as a notification within the group chat interface/window that appears differently from messages sent by group members. Because the updates are presented in the group chat interface/window along with other messages that are sent among the distribution group members, a group member can easily review past updates associated with the store among messages, if any, sent by the group members simply by scrolling through the history of messages within the group chat interface/window.

In some embodiments, because each distribution group user's position relative to the store is stored by the messaging service, in the group chat interface/window in which the update associated with the store is displayed for each user within the messaging application executing at the user's device, each distribution group user's position is also displayed with each user's name/handle in the interface/window. This way, users within the group chat interface/window can quickly recognize each user's role within or relative to the store to be able to engage in efficient work-related communication and also fast task assignments.

In some embodiments, organization management events, such as alerts and review and approval events that are generated with respect to the distribution group, may be distributed to group members of the corresponding store management positions. As such, in some embodiments, alerts with respect to the store that affect only a subset of distribution group members of particular positions with respect to the store can be sent directly to those users and appear within the messaging application in a separate chat interface/window or appear as a text message or phone call. For example, when the distribution group membership is updated (e.g., former users replaced by new users) in response to received updates to a change in store personnel at the transaction platform, the server can automatically and accordingly update its stored relationships between store management positions and group members. Thus, the messaging service or group members need only focus on store management positions within the distribution group without having to focus on particular group members.

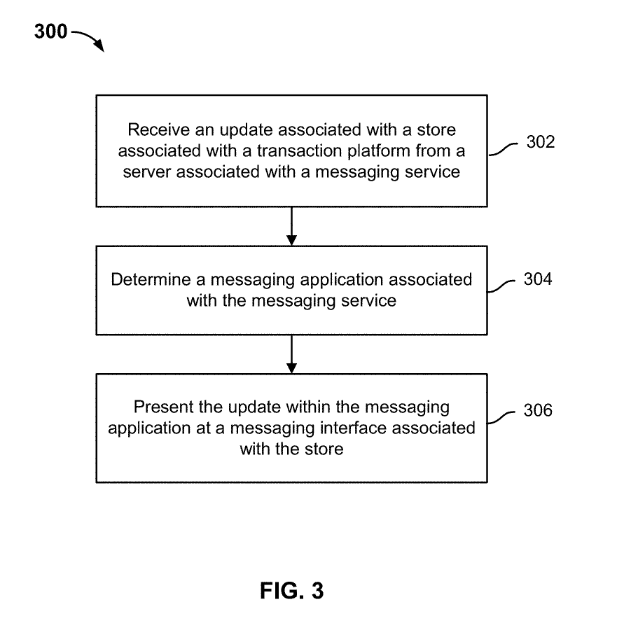

FIG. 3 is a flow diagram showing an embodiment of a process for presenting an update associated with a transaction platform within a messaging application. In some embodiments, process 300 is implemented, at least in part, at mobile device 14 or computer 15 of FIG. 1.

At 302, an update associated with a store associated with a transaction platform is received from a server associated with a messaging service.

In some embodiments, a user has already logged into a messaging application that is executing at the device of the client. The user has been included in a distribution group that has a binding relationship with a store of a transaction platform with which the update is associated. For example, the user may have been a manager with respect to the store and had requested that the store be bound to the distribution group. In the event that the user is the manager of the store, the user was also permitted to add/remove users into the distribution group that is bound to the store. In another example, the user may be a non-manager employee/staff member of the store or another individual affiliated with the store (e.g., a vendor). As mentioned above, the update may include activity with respect to the store, such as activity with respect to the merchandise that is sold by the store as well as buyer users that have made purchases and/or are browsing at the online store.

As mentioned above, in some embodiments, a store is requested to be bound to an organization that is recognized by the messaging service. Therefore, information that is maintained by the messaging service regarding the organization (e.g., name, information on the members of the organization) may be reused for the distribution group that includes at least a subset of the members of the organization. As a result, information on the organization members may be conveniently introduced into the distribution group to form the membership of the distribution group without the need to manually add users one at a time. User operations can be greatly simplified in this way.

At 304, a messaging application associated with the message service is determined.

In some embodiments, the update includes identifying information associated with the messaging service to which it was sent and a corresponding client messaging application is determined at the device and executed/launched/opened.

At 306, the update is presented within the messaging application at a messaging interface associated with the store.

A group chat interface/window for users of the distribution group that is bound to the store with which the update is associated is opened within the messaging application. The received update is then displayed within the group chat interface. In some embodiments, any previous messages that were sent among the distribution group members or any updates associated with the store that were previously pushed to the distribution group members are also presented within the group chat interface/window of the messaging application. In some embodiments, the update may appear as a notification message that is not associated with any particular user of the distribution group. In some embodiments, the update appears as a message that is attributed to a computerized assistant (e.g., a chatbot). In addition to presenting updates associated with the store, messages that are sent among the users of the distribution group may also be presented within the same group chat interface/window of the messaging application. In some embodiments, identifying information of each user of the distribution group is also presented in the group chat interface/window of the messaging application.

In some embodiments, within the group chat interface/window of the messaging application, each message that is sent by a user to the distribution group is presented with information pertaining to the user who had sent the message. For example, next to the message of each user that had sent the message, one or more of the following may be presented with the message: a name or handle of the user and a position within the store that is held by that user. By presenting users' positions with respect to the store, the users of the distribution group may better know how to address each other in the context of the group chat that includes automated store-related updates from the transaction platform.

In some embodiments, when the distribution group is associated with an organization, activation portals for application functions associated with the store of the transaction platform may be presented in an interface of the messaging application that is associated with the organization so that the members of the distribution group may use this organization function interface to quickly activate the corresponding application functions. The organization function interface may include activation portals for preset processing functions associated with the any one organization. For example, the preset processing functions may include micro-application functions, mini-program functions, or original built-in (native) functions. The preset processing functions may be available to internal or external members of the any one organization for implementation of specific processing relating to the any one organization. In some embodiments, the application functions pertain to the store and may include one or more of the following related to market activity: “Punching in” (e.g., to be used by distribution group members to punch in when their shift with respect to the online store begins), “Teleconference” (e.g., to be used by distribution group members to have a group phone call), “Signing in” (e.g., to be used by distribution group members to sign into the distribution group chat interface/window), and “Business journal” (e.g., to be used by distribution group members to view historical transaction activity with respect to the store). In some embodiments, a distribution group member can navigate to the interface related to the organization within the messaging application to select the activation portals related to the application functions.

In some embodiments, functions associated with a distribution group that is bound to a store may be presented in the group chat interface/window corresponding to the distribution group. As a result, the group members can quickly browse function data related to the store even if they do not choose to activate these application functions. Group members are thus able to acquire the function data with much greater efficiency. In some embodiments, data related to the functions may be presented in a floating window within a chat interface. Consequently, as group members flip through pages of or scroll through the historical chat messages of the group chat interface, the display position of the function data on the screen does not correspondingly change, thus allowing the distribution group members to view it at any time. In some embodiments, the distribution group administrator (i.e., the group member that is associated with the management/administrator role at the store) may assign uniform application functions to all group members so that the function data that all group members see within the messaging application executing on their own user devices is the same. In some embodiments, the distribution group administrator may assign different individual group members a specific set of application functions that they have permission to view/use, with the result that the function data specific to each user is viewable in a floating window in the group chat interface/window within the messaging application executing on the user's own device.

By implementing cross-platform function operations between a transaction platform and a messaging service (e.g., which are implemented by separate severs), real-time or other updates with respect to a store at the transaction platform are automatically pushed to the group chat interface/windows of the messaging applications of users of the messaging service that are assigned to a distribution group that is bound to the store. This enables the distribution group members, which include the staff members of the store, to promptly learn of store-related information that is generated at the transaction platform without needing to separately check the network platform, which may require signing into and/or accessing a separate application executing at the client device. Furthermore, the distribution group members may continue to send messages to each other within the same group chat interface/window in which the store updates are displayed so they can conveniently and efficiently discuss with each other how to respond to the updates. A manager of the store can use the group chat to centrally manage the staff and ensure that store updates are promptly transmitted to the store's staff.

FIG. 4 is a flow diagram showing an embodiment of a process for creating a distribution group associated with an organization. In some embodiments, process 400 is implemented, at least in part, at second server 12 of FIG. 1.

Process 400 describes an example process for creating an organization with a messaging service. In some embodiments, process 400 is performed before process 300 of FIG. 3.

At 402, profile information associated with an organization is received. A user using a messaging application can make a selection to initiate the creation of an organization to be recognized by the messaging service with which the application is associated. The messaging application may then present one or more interfaces through which the user can submit profile information associated with the organization. For example, profile information may include the name of the organization, the description of the organization, one or more members (e.g., the names, contact information associated with the members, identifying information of devices used by the members) to be associated with the organization, and/or other attributes associated with the organization. In various embodiments, each member of the organization is also a registered user of the messaging service.

At 404, identifying information associated with one or more users to be included in the distribution group is received. At least a subset of the members of the organization can be designated by a user to be included in a distribution group associated with the organization. Members of the distribution group are to receive updates associated with a store to which the organization is to be bound within the same group chat interface that is configured to be displayed within each distribution group member's messaging application that is executing at his or her respective device. Therefore, when a distribution group is created, information about organization members may be reused for those members that are selected to be included in the distribution group.

At 406, the profile information associated with the organization and the identifying information associated with the one or more users are stored for the distribution group. Profile information and the distribution group for the organization are stored by the messaging service such that the organization and the distribution thereof may be searched.

FIG. 5 is a flow diagram showing an embodiment of a process for binding a distribution group associated with a messaging service to a store associated with a transaction platform. In some embodiments, process 500 is implemented, at least in part, at second server 12 of FIG. 1.

At 502, a binding request is received from a messaging application that is executing at a device, wherein the binding request includes identification information associated with a store associated with a transaction platform, identifying information associated with a distribution group associated with a messaging service associated with the messaging application, and identifying information associated with a user that is signed into the messaging application.

A user that is using a messaging application at a device may wish to bind a store (with whom the user is affiliated) of a transaction platform to a distribution group of users, who are all registered users of the messaging service corresponding to the messaging application. In some embodiments, the distribution group is associated with an organization that has been created with the messaging service and so the binding request identifies the organization with which the distribution group is associated. The user may select a control that is presented at the messaging application that enables the user to send a binding request. For example, in selecting the binding request, the messaging application may solicit certain pieces of information from the user, including for example, the name of the store at the transaction platform and the name of the organization with which the distribution group is associated at the messaging service. Given that the user that has selected to send the binding request is already signed in at the messaging application, in some embodiments, the messaging application is configured to include at least some information associated with the signed-in account into the binding request. For example, information associated with the signed-in account may include identifying information associated with the requesting user (e.g., name, username, password) and identifying information associated with the device (e.g., the phone number, a hardware address) that is used by the requesting user.

At 504, the binding request is sent to a server associated with the transaction platform, wherein the server associated with the transaction platform is configured to determine whether the user is authorized to bind the distribution group to the store based at least in part on the identification information associated with the user.

The binding request is forwarded from the device on which the messaging application was executing to the server associated with the messaging service. In some embodiments, the server associated with the transaction platform is configured to check the identifying information associated with the requesting user (e.g., name, username, password, phone number, and/or device hardware address) against stored information associated with one or more manager/administrator roles with respect to the online store that is identified in the binding request. If the server associated with the transaction platform determines that the identifying information associated with the requesting user matches that of a manager/administrator role with respect to the online store that is identified in the binding request, then it means that the requesting user has authority/permission to request the creation of the binding relationship between the organization/distribution group and the store. If the requesting user has such authority/permission, then the server associated with the transaction platform will create the binding relationship by storing data indicating that the relationship exists and will also send a response back to the server associated with the messaging service indicating that the requesting user has such authority. Once a binding relationship has been established between the store of the transaction platform and the distribution group of the messaging service, then when a subsequent update is generated at the transaction platform with respect to the store, the server associated with the transaction platform will send the update along with identifying information associated with the distribution group (or the organization thereof) to instruct the server associated with the messaging service to push the update to the devices of the members of the distribution group, as described above.

Otherwise, if the requesting user does not have such authority/permission, then the server associated with the transaction platform will send a response that indicates that the requesting user does not have such permission. In some embodiments, if the requesting user does not have such authority/permission, in the response back to the server associated with the messaging service, identifying information associated with another user that the server associated with the transaction platform has stored as being in a manager/administrator role with respect to the store is sent to the server associated with the messaging service.

At 506, a response is received from the server associated with the transaction platform, wherein the response indicates whether the user is authorized to bind the distribution group to the store.

At 508, based at least in part on the response, it is determined whether to enable updates associated with the store to be pushed to respective one or more devices corresponding to one or more users that are included in the distribution group.

If the response indicates that the requesting user does have authority/permission to create the binding relationship, then the messaging service will send an indication to the messaging application to present a confirmation that the relationship has been created. When subsequent updates related to the store are sent from the server associated with the transaction platform to the server associated with the messaging service, such updates are pushed by the server associated with the messaging service to the devices of the members of the distribution group, including that of the requesting user (if the requesting user is also in the distribution group).

In some embodiments, if the response indicates that the requesting user does not have authority/permission to create the binding relationship but the response also includes the identifying information associated with another user that the server associated with the transaction platform has stored as being in a manager/administrator role with respect to the store, then the server associated with the messaging service may forward a prompt to the other identified user. The prompt includes a control associated with approving the creation of the binding relationship between the store and the distribution group such that even if the user associated with the manager/administrator role with respect to the store is not the user to initially request for the relationship, the request can be directed to that user for that user to approve and therefore allow to be created by the server associated with the transaction platform.

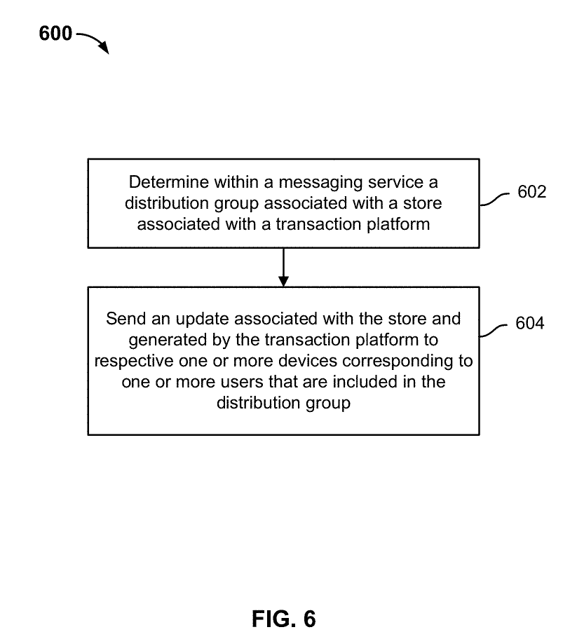

FIG. 6 is a flow diagram showing an embodiment of a process for sending updates associated with a transaction platform to a distribution group of users associated with a messaging service. In some embodiments, process 600 is implemented, at least in part, at second server 12 of FIG. 1.

At 602, within a messaging service, a distribution group associated with a store associated with a transaction platform is determined.

In some embodiments, a messaging service may enable users to create a distribution group. The distribution group includes one or more users of the messaging service that are able to participate in a single group chat, for example. In some embodiments, the messaging service includes a function that permits a distribution group to have a binding relationship to an online store that is part of a transaction platform. Once a distribution group has a binding relationship with the store, updates with respect to the store that are generated by the transaction platform are sent to the messaging service (e.g., via an API that is used by the messaging service) for the messaging service to push to the devices of the users within the distribution group. For example, the transaction platform can call an API that is provided by the messaging service to transmit store updates to the messaging service. Each distribution group member may then view the store-related updates within the messaging application that is executing locally at his or her device.

In various embodiments, the transaction platform may include a network transaction platform where seller-provided, merchandise-related information is made available for viewing by buyers, and buyers and sellers may choose to conduct transactions either online or offline.

In some embodiments, the members of the distribution group may be subject to group-wide operations. In particular, changes in group settings (e.g., privacy, preferences, message layouts) affect all the distribution group members.

In some embodiments, when a binding request is received from a user to bind a distribution group to the store, the user's account information is used to determine (e.g., by querying the transaction platform server) whether that user has a manager/administrator role with respect to the store. For example, the requesting user's identifying information is compared against that of the user with the manager/administrator role with respect to the store to determine if there is a match. If there is a match, then the requesting user is verified to have authority to request the binding relationship. For example, the user with the manager/administrator role with respect to the store is the person in charge of the store or is the store manager.

In some embodiments, a binding relationship is first requested to bind an organization that is recognized by the messaging service to the store associated with the transaction platform and then a distribution group of users is created to be associated with the store/organization. The members of the distribution group include the members of at least one organization. For example, the name of this organization may be the same as or similar to the name of the store, and consequently the messaging service may be able to automatically relate the two to each other. Or the messaging application may give priority in recommending the organization to the user with the manager/administrator role with respect to the store.

In some embodiments, by associating a store of the transaction platform to an organization on the messaging service, it is possible to reuse information maintained by the messaging service on the members within the organization. Since the messaging service already stores information on the members of the organization, once members of the organization are included into a distribution group, the stored information on those members of the organization can be associated with the distribution group, without needing to solicit further information from the user that is creating the group. As a result, information maintained by the messaging members on the organization members may be conveniently introduced into the distribution group to form the membership of the group without the need to manually add users one at a time. User operations can be greatly simplified in this way. In some other embodiments, the store may be unrelated to an organization.

At 604, an update associated with the store and generated by the transaction platform is sent to respective one or more devices corresponding to one or more users that are included in the distribution group.

In some embodiments, the members of the distribution group include the staff members of the store of the transaction platform. For example, the staff members of the store may include at least one of the following: users assigned on the transaction platform by a manager of the store and users assigned on the messaging service by an administrator of the distribution group (e.g., the user that had created the distribution group or the distribution group member that has been assigned the role of the distribution group administrator).

In some embodiments, the store manager may pre-assign the store's staff member's position with respect to the store (e.g., the person in charge of the store, the person in charge of the enterprise that produces the merchandise, sales personnel, and customer service personnel) on the transaction platform. Information about the staff members may be automatically and/or periodically synchronized from the transaction platform to the messaging service without the need for user invention. After determining the distribution group at the messaging service that is associated with the store at the transaction platform, the store manager may assign store staff's positions through the transaction platform, and the messaging service may update distribution group members based on the assignment results that are received from the transaction platform by, for example, automatically adding new staff and automatically removing deleted staff.

In some embodiments, the distribution group administrator may assign the store's staff in a messaging application associated with the messaging service. For example, the group administrator may use staff contact numbers, email addresses, associated organizations, and friend relationships with other users to look up registered accounts corresponding to these staffers within the messaging application and then assign them as members of the distribution group. To give another example, even if some staff members do not yet have registered accounts with the messaging application, they may be added first to the distribution group, and their contact information such as phone numbers and email addresses may be entered into the messaging application. As a result, the messaging application may send registration prompts to them using their received contact information. Thereupon, the corresponding distribution group memberships may be activated after each staff member completes messaging service account registrations based on the registration prompts.

In some embodiments, organization management events such as alerts and review and approval events that are generated in the distribution group may be distributed to corresponding store management positions so that the messaging service server may bind group members based on store management positions and push organization management events to the corresponding distribution group members. For example, when group membership is updated (e.g., former users replaced by new users) at the messaging service, the messaging service server can automatically and accordingly update the binding relationships between store management positions and group members. Thus, system or group members need only focus on store management positions within the group without having to focus on bound group members. That is, it is possible to ensure that the server can send the appropriate organization management events to the corresponding distribution group members.

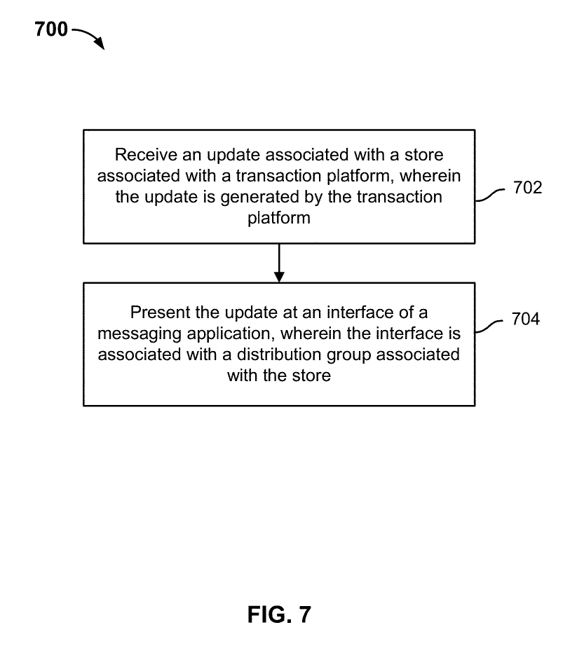

FIG. 7 is a flow diagram showing an embodiment of a process for presenting an update associated with a store within a messaging application. In some embodiments, process 700 is implemented, at least in part, at mobile device 14 or computer 15 of FIG. 1.

At 702, an update associated with a store associated with a transaction platform is received, wherein the update is generated by the transaction platform.

A binding relationship has been established between a store associated with the transaction platform and a distribution group at a messaging service. The distribution group is created at and recognized by the messaging service such that members of the distribution group are able to perform actions with respect to the entire group (e.g., send messages to the group at once).

In some embodiments, the binding relationship between the store and the distribution group was established after a user that had been logged in at a messaging application issued a binding request to the messaging service server associated with the messaging application. In some embodiments, after the messaging service server determines that the logged-in user has management authority vis-à-vis the store at the transaction platform (e.g., that is implemented by a separate server), the user is granted permission to determine the distribution group associated with the store in the messaging application. In other words, when the logged-in user has management authority in relation to the store, e.g., the logged-in user is the person in charge of the store or is the store manager, the logged-in user is permitted/enabled to determine the distribution group associated with the store in the messaging application. In some embodiments, the user that created the distribution group becomes the default administrator of the administrator group (until that role is explicitly reassigned).

At 704, the update is presented at an interface of a messaging application, wherein the interface is associated with a distribution group associated with the store.

In some embodiments, in a presenting region (e.g., interface) within a messaging application, a store position identifier corresponding to a corresponding store management position is presented for each distribution group member. For example, the associated presenting region may include at least one of the following: a personal information interface for the distribution group members, a presenting region corresponding to the distribution group members in a distribution group member management interface for the group, and a presenting region for communication messages sent among the distribution group. The presentation of position identifiers corresponding to the various store management positions helps distribution group members to quickly recognize each other's store management positions and thus achieve efficient work communications, fast task assignments, and so on.

In some embodiments, when the distribution group is associated with any one organization, activation portals for application functions associated with the store may be presented in the organization function interface of the organization so that the distribution group members of the group may use this organization function interface to easily activate the application functions. The organization functions interface may include activation portals for preset processing functions associated with the any one organization. For example, the preset processing functions may include micro-application functions, mini-program functions, or original built-in functions. The preset processing functions may be available to internal or external members of the organization for implementation of specific processing relating to the organization.

The received update associated with the store is presented within an interface and is associated with a distribution group. In some embodiments, the interface may include any interface associated with the distribution group. For example, the interface may include a chat interface corresponding to the distribution group, a portal interface corresponding to the chat interface, or an unread message interface corresponding to the distribution group.

In some embodiments, functions associated with a distribution group that is bound to a store may be presented in the group chat interface/window corresponding to the distribution group. As a result, the group members can quickly browse function data related to the store even if they do not choose to activate these application functions. Group members are thus able to acquire the function data with much greater efficiency. In some embodiments, data related to the functions may be presented in a floating window within a chat interface. Consequently, as group members flip through pages of or scroll through the historical chat messages of the group chat interface, the display position of the function data on the screen does not correspondingly change, thus allowing the distribution group members to view it at any time. In some embodiments, the distribution group administrator (i.e., the group member that is associated with the management/administrator role at the store) may assign uniform application functions to all group members so that the function data that all group members see within the messaging application executing on their own user devices is the same. In some embodiments, the distribution group administrator may assign different individual group members a specific set of application functions that they have permission to view/use, with the result that the function data specific to each user is viewable in a floating window in the group chat interface/window within the messaging application executing on the user's own device.

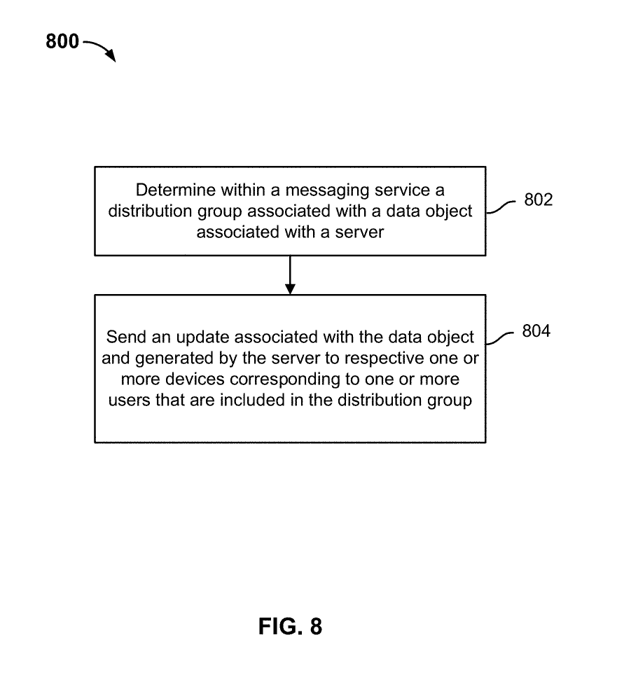

FIG. 8 is a flow diagram showing an embodiment of a process for sending updates associated with a platform to a distribution group of users associated with a messaging service. In some embodiments, process 800 is implemented, at least in part, at second server 12 of FIG. 1.

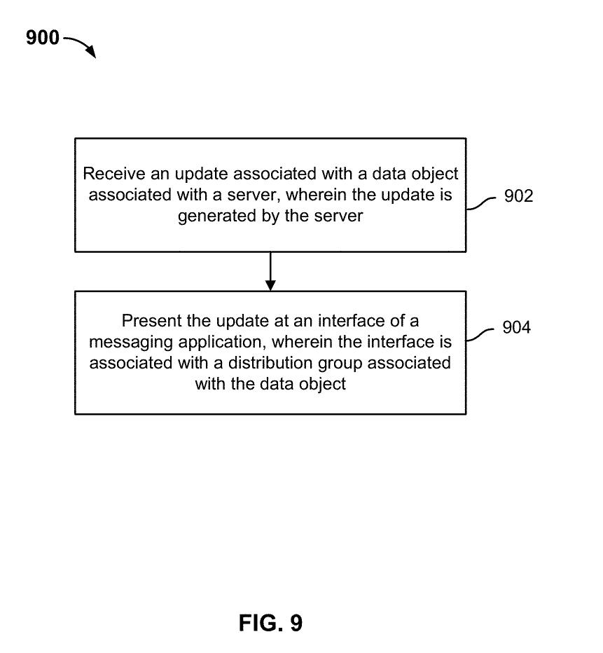

At 802, within a messaging service, a distribution group associated with a data object associated with a server is determined. A “data object” may vary depending on the processing platform that is implemented by the server, as will be described below for both FIGS. 8 and 9.

At 804, an update associated with the data object and generated by the server is sent to respective one or more devices corresponding to one or more users included in the distribution group.

FIG. 9 is a flow diagram showing an embodiment of a process for presenting an update associated with a server within a messaging application. In some embodiments, process 900 is implemented, at least in part, at mobile device 14 or computer 15 of FIG. 1.

At 902, an update associated with a data object associated with a server is received, wherein the update is generated by the server.

At 904, the update is presented at an interface of a messaging application, wherein the interface is associated with a distribution group associated with the data object.

In FIGS. 8 and 9 above, for example, the server may be configured to provide a processing platform such that data objects maintained on the server are associated with corresponding processing operations at the processing platform. The server may obtain information relating to the data objects and share this information with a distribution group at a messaging service so that data may be shared between the server and the devices associated with users that are included in the distribution group.

In some embodiments, data objects are configured on a server. The data objects implement corresponding processing operations based on the processing platform provided by the server. The data objects may run autonomously and generate information associated with the data objects, such as run results obtained by the data objects. Or a user may access a processing platform provided by the server and implement processing operations that correspond to the data objects and which generate information associated with the data objects.

In some embodiments, the messaging service app may include a server program and a client program, with the server program running on a server computer and the client program/application running on a user device. The server program may receive information generated by the server associated with the data objects and send this information to a group, with the result that group members receive and view this information via client programs running on the respective user devices.

The technical scheme of this processing platform may be applied to multiple application scenarios. For example:

In a transaction context, the processing platform of FIGS. 8 and 9 may include a transaction platform. The data objects may include stores on the transaction platform, and sellers may use the transaction platform to provide information about merchandise to the stores. Buyers may use the transaction platform to browse information about the merchandise and perform transaction operations directed at the merchandise. The transaction platform may acquire platform transaction volumes, store unique visitors, and other such updates in order to share it with the distribution groups associated with a messaging service that store staff (e.g., sellers) belongs to.

In a production context, the processing platform may include an assembly line control platform. The data objects may include assembly line objects corresponding to each assembly line. For example, the processing platform may be an automobile production line control platform and the data objects may be cars. The assembly line control platform may exercise control over each assembly line based on the assembly line objects. Accordingly, information relating to the data objects may include overall production efficiency of each assembly line, individual assembly line yields, and so on. The assembly line control platform may share this with the distribution groups that assembly line workers belong to.

In a distribution context, the processing platform may include a distribution control platform, and the data objects may include distribution point objects corresponding to each distribution point. For example, the processing platform may be a logistics control platform and the data objects may be packages. The distribution control platform may exercise control over each distribution point based on the distribution point objects. Accordingly, information relating to the data objects may include the overall number of express delivery personnel for each distribution point, the number of express delivery items at individual distribution points, and the overall average delivery time. The distribution control platform may share this with the groups that distribution point personnel belong to.

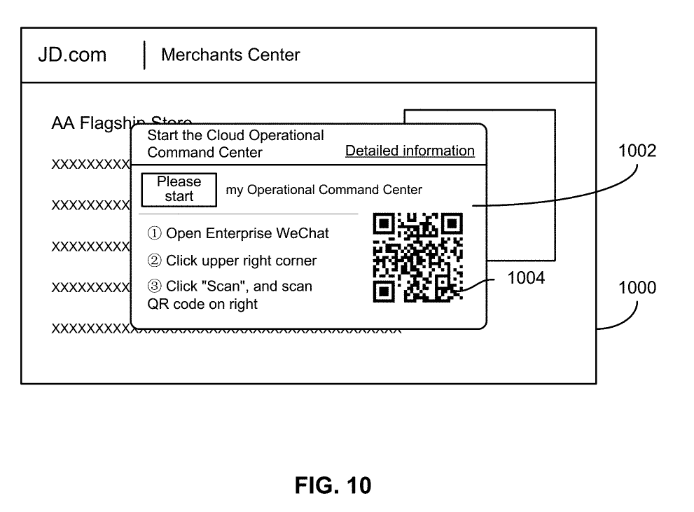

FIGS. 10 through 31 show examples of interfaces associated with either a transaction platform or a messaging application that show examples of sending updates associated with a transaction platform to a distribution group of users associated with a messaging service in accordance to some embodiments.

For purposes of illustration, in FIGS. 10 through 31, the messaging service is referred to as an “enterprise instant messaging service.” Specifically, the example enterprise instant messaging service that is referred to in FIGS. 10 through 31 is referred to as “Enterprise WeChat” and is implemented by a server. In such examples, the transaction platform that is implemented by a server that is different than the one that is used to implement the Enterprise WeChat service is referred to as “JD.com.” Also, in the examples of FIGS. 10 through 31, online stores at the transaction platform are accessible via a web browser or other application executing at a device. Furthermore, in the examples, the Enterprise WeChat messaging service is accessible through messaging applications that are executing at respective devices. The store at JD.com that is referred to in the examples below is referred to as the “AA Flagship Store” and the user that has the manager/administrator role with respect to “AA Flagship Store” (e.g., as indicated in data stored by JD.com) is user A. As will be shown in FIGS. 10 through 31 below, User A can browse JD.com using a device (e.g., a computer) and then use the Enterprise WeChat messaging application that is executing at a mobile phone to request for the “AA Flagship Store” to have a binding relationship to a distribution group that is recognized by the Enterprise WeChat messaging service in order for the users of the distribution group to receive update information on JD.com relating to “AA Flagship Store” within their respective Enterprise WeChat messaging applications so that the users (who may be staff members of “AA Flagship Store”) can be kept apprised of (e.g., real-time) developments on “AA Flagship Store” and also discuss among themselves within the same group chat interface in which the updates are presented.

FIG. 10 is a diagram of an example function guide interface at a website or application associated with the transaction platform. As shown in FIG. 10, user A can access web page 1000 through a web browser at a computer (e.g., computer 15 of FIG. 1) by navigating within JD.com. Web page 1000 shows a prompt related to “AA Flagship Store” and includes instructions for a user to create a binding relationship between “AA Flagship Store” and a distribution group of users at Enterprise WeChat. In the examples shown in FIGS. 10 through 31, functions related to receiving updates from JD.com or some other transaction platform at Enterprise WeChat are associated with “Cloud Operational Command Center” functions via “Enterprise WeChat.” Other example names that could be used in lieu of “Cloud Operational Common Center” include “Cloud War Room,” “Double Eleven War Room,” “Merchant War Room,” “Merchant Operational Commander Center,” “Merchant Cloud War Room,” and “Ecommerce Command Center.”

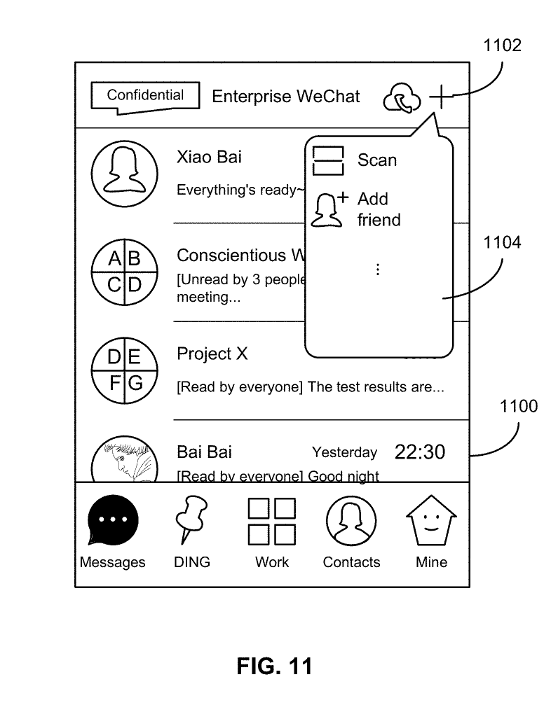

FIG. 11 is a diagram of an example messaging application interface for sending a binding request to bind an organization that is recognized by the messaging service to a store of the transaction platform. User A may implement the appropriate operations in accordance with the guide instructions that were shown in function guide interface 1002 of FIG. 10: 1) Open Enterprise WeChat. User A can launch the Enterprise WeChat client application running on a device (e.g., mobile device 14 of FIG. 1). After the Enterprise WeChat client application has been launched, the Enterprise WeChat client application presents chat list interface 1100 as a default interface, as shown in FIG. 11. Chat interface list 1100 is configured to present interface portals for some function interfaces. These function interfaces may include chat interfaces corresponding to chats which user A is participating in (e.g., various chats with Xiao Bai, Project X, and Bai Bai). 2) Click upper right corner. Function identifier 1102 appears in the form of a “+” in the upper right corner of chat list 1100. When user A selects function identifier 1102, function menu 1104 is triggered to be presented, as shown in FIG. 1100. Function menu 1104 includes “Scan,” “Add Friend,” and several other function options for implementing the corresponding operation functions. 3) Click “Scan”, and scan QR code on right. When user A selects the “Scan” option in function menu 1104, Enterprise WeChat can acquire application authority for the camera on mobile device 14 and, using the camera, photograph and recognize QR code 1004 shown in FIG. 10.

QR code 1004 of FIG. 10 is encoded with a web address or other information associated with the “AA Flagship Store” (for which user A belongs in accordance to data that is stored at JD.com), the “Operational Command Center,” and other such information. Using the Enterprise WeChat client to scan QR code 1004 shown in FIG. 10 causes the Enterprise WeChat client to send to the server associated with JD.com a binding request that requests to bind “AA Flagship Store” to an organization that is recognized at (e.g., identifying information of the organization is stored by) the Enterprise WeChat such that the Cloud Operational Command Center for “AA Flagship Store” can be available to user A at the Enterprise WeChat client application. If user A does not successfully scan QR code 1004 of FIG. 10 with the Enterprise WeChat client, the user can be guided to start or download the Enterprise WeChat client and to rescan using the Enterprise WeChat client. While scanning a QR code provided by the transaction platform (JD.com) using a messaging application (Enterprise WeChat) is the example shown for a form of cross-platform exchange of information, others ways of achieving cross-platform exchange of information or data between the messaging service and transaction platform may be used in practice. For example, a user may open a website associated with JD.com on an Enterprise WeChat client and input specific information on the Enterprise WeChat client pertaining to “AA Flagship Store” to initiate the binding process.

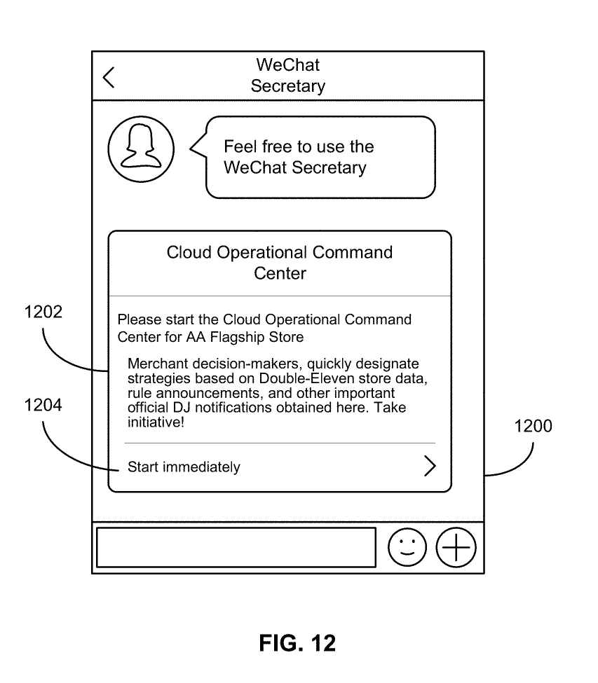

FIG. 12 is a diagram of an example messaging application interface associated with starting the Cloud Operational Command Center. As shown in FIG. 12, the Enterprise WeChat client may use a personified mode such as “WeChat Secretary” to receive notifications through system notification interface 1200. For example, after the Enterprise WeChat client application obtains the relevant information through QR code 1004 of FIG. 10, it can present function start notification 1202 in system notification interface 1200, as shown in FIG. 12. As a result, user A can, by selecting start option 1204 that is included in function start notification 1202, start using the Cloud Operational Command Center for “AA Flagship Store.” In the example, system notification interface 1200 describes that updates/notifications regarding “AA Flagship Store” may be received from JD.com with respect to “Double-Eleven,” which is a holiday and promotional event during which more store activity is typically anticipated.

In some embodiments, the Enterprise WeChat client application is configured to check its own version information. If the version of the Enterprise WeChat client application that is executing on the device is an older one that is unable to support the relevant functions of “Cloud Operational Command Center,” user A can be prompted by the Enterprise WeChat client application to update the Enterprise WeChat client application to a newer version. If the user does not proceed to update the client application, the processing flow to activate the Cloud Operational Command Center for “AA Flagship Store” will end.

In various embodiments, the ability by a user to use the Cloud Operational Command Center for “AA Flagship Store” on the Enterprise WeChat client application involves alignment and cooperation between two platforms: Enterprise WeChat and JD.com. Therefore, when user A wishes to start using the Enterprise WeChat client application to receive updates/notifications from “AA Flagship Store” at JD.com, the Enterprise WeChat client application and/or JD.com will have to verify whether the requesting user has the relevant authorizations. First of all, the Enterprise WeChat client application can obtain account information, e.g., the account number, of the logged-in user at the device. Then the Enterprise WeChat client application is configured to issue a verification request based on the account information to JD.com. For example, JD.com then determines whether the management account of “AA Flagship Store” that is stored at JD.com corresponds to the account information obtained by Enterprise WeChat.

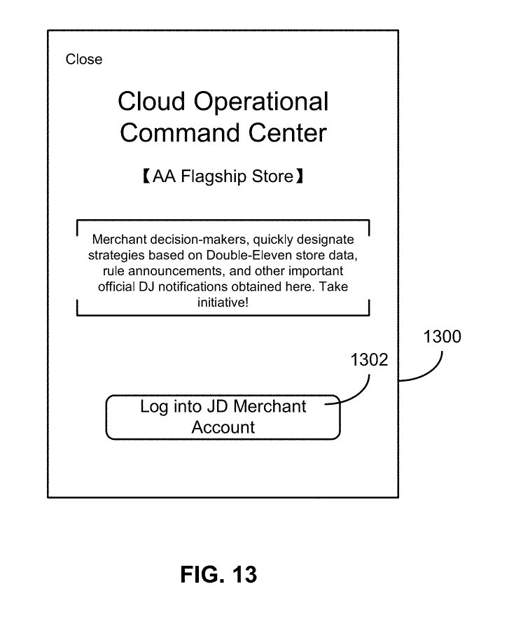

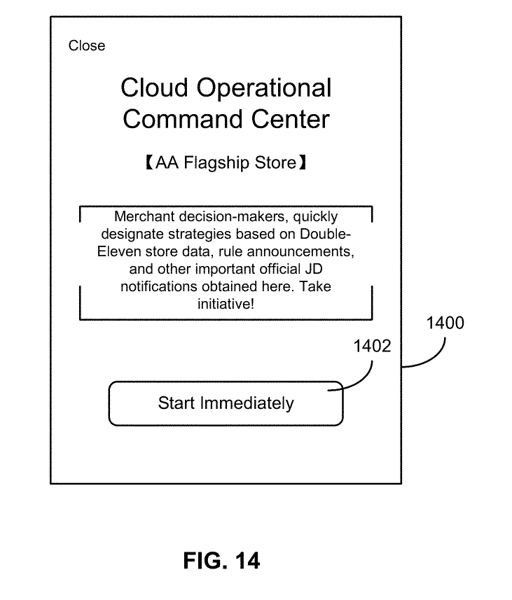

A mobile phone number is an example piece of account information that is obtained for the logged-in user by the Enterprise WeChat client application and sent to the server associated with JD.com. When the mobile phone number of the logged-in user on the Enterprise WeChat client application differs from the mobile phone number of the management account of “AA Flagship Store” on JD.com, the Enterprise WeChat client application may present the account login guide interface 1300 shown in FIG. 13 to enable user A to trigger cross-platform login option 1302 and thereby allow user A to enter the management account number/name/ID and login password that user A knows for “AA Flagship Store” on JD.com. If the login account number entered by user A is indeed the management account number of “AA Flagship Store,” and if the login password is verified as correct, the logged-in user on the Enterprise WeChat client application can be confirmed as having management authority over “AA Flagship Store” on JD.com. The Enterprise WeChat client application can show function start guide interface 1400 (shown in FIG. 14) so that user A can select function start option 1402 in function start guide interface 1400 and thereby enter the subsequent processing flow.

When the mobile phone number of the logged-in user on the Enterprise WeChat client is the same as the mobile phone number of the management account of “AA Flagship Store” on JD.com, the Enterprise WeChat client can directly determine the logged-in user's management authority vis-à-vis “AA Flagship Store” on JD.com. Thus, it skips presenting account login guide interface 1300 shown in FIG. 13 and directly enters function start guide interface 1400 shown in FIG. 14.

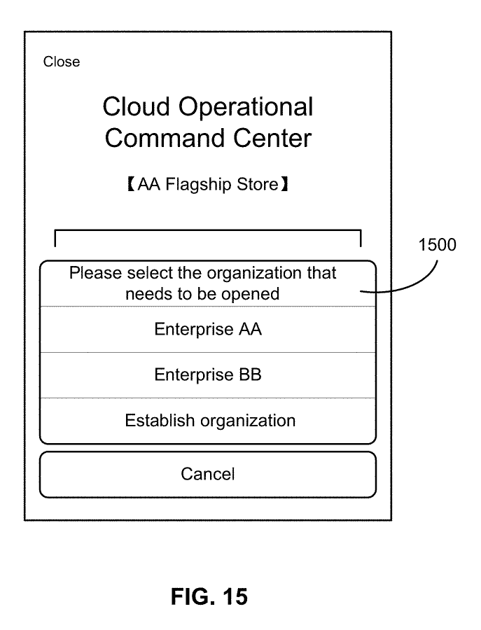

FIG. 15 is a diagram of an example messaging application interface for binding an organization to a store of the transaction platform. As a result of the selection operation by user A with respect to start operation 1402 of interface 1400 of FIG. 14, the Enterprise WeChat client application can present organization binding interface 1500 as shown in FIG. 15 to enable user A to bind at least one organization to “AA Flagship Store” of JD.com and to start the “Cloud Operational Command Center” function for the bound organization. At organization binding interface 1500, two organizations that have been previously established at Enterprise WeChat (“Enterprise AA” and “Enterprise BB”) by user A (e.g., and to which user A belongs) are presented as options to be selected. Organization binding interface 1500 also presents a third option (“Establish organization”) for user A to create a new organization to which to bind “AA Flagship Store.” A distribution group of users of Enterprise WeChat may be established for an organization before it is bound to a store at the transaction platform or may be established for an organization after it is bound to a store at the transaction platform. In another example, instead of binding an organization to a store, the store is directly bound to a distribution group at the messaging service and the distribution group is not necessarily associated with an organization.

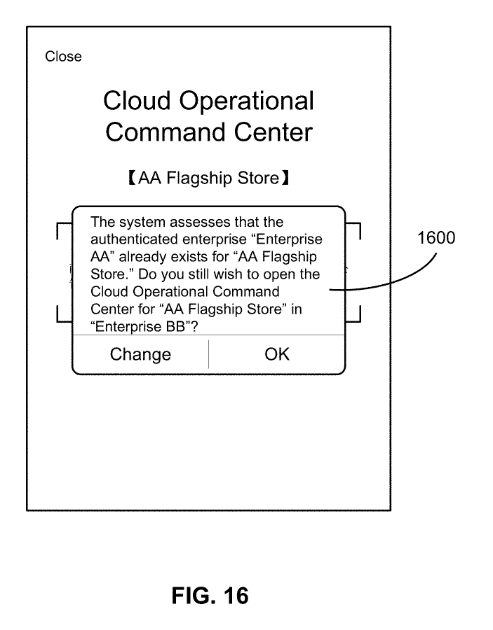

For example, if user A selects enterprise BB in organization binding interface 1500 shown in FIG. 15, the Enterprise WeChat client application executing locally or the Enterprise WeChat server can provide user A with a prompt based on the relationships between “AA Flagship Store” and each organization name that is available for selection. The relationship may include name match level and enterprise type. For example, FIG. 16 is a diagram of a messaging application interface for an organization binding confirmation. As shown in FIG. 16, when the aforementioned relationship includes name match level, the name match level between “AA Flagship Store” and Enterprise AA is significantly higher than the name match level between “AA Flagship Store” and Enterprise BB, which suggests that there may exist a user operating error in selecting Enterprise BB. Therefore, as shown in FIG. 16, the Enterprise WeChat client application may present organization binding confirmation interface 1600 to prompt user A to confirm whether it should be Enterprise AA rather than Enterprise BB that is selected to be bound to “AA Flagship Store.” If user A finds that an operating error does indeed exist, user A may return to organization binding interface 1500 shown in FIG. 15 by triggering the “Change” option in organization binding confirmation interface 1600. If user A does not believe that there has been an operating error, user A can confirm the selection of Enterprise BB by selecting the “OK” option in organization binding confirmation interface 1600. To give another example, assume that the enterprise type of “AA Flagship Store” is food retail and that the enterprise type of Enterprise BB is machining. The two enterprise types are different and based on that determination, the Enterprise WeChat client can likewise send to user A the confirmation prompt shown in FIG. 16 in order to correct user A's potential selections error.

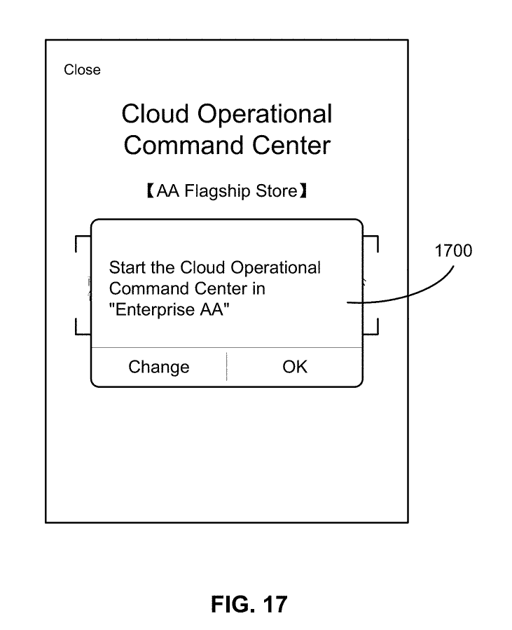

FIG. 17 is a diagram of an example messaging application interface for selection confirmation. After user A selects Enterprise AA at organization binding interface 1500 of FIG. 15, the Enterprise WeChat client application can directly confirm user A's selection. Or the Enterprise WeChat client application can display selection confirmation interface 1600 of FIG. 16 to enable user A to reconfirm their selection. If there is a selection error that the Enterprise WeChat client application or the Enterprise WeChat server failed to discover, user A can return to organization binding interface 1500 shown in FIG. 15 by selecting the “Change” option in selection confirmation interface 1700. If user A believes that there has been no selection error, they can confirm by selecting the “OK” option in selection confirmation interface 1700.

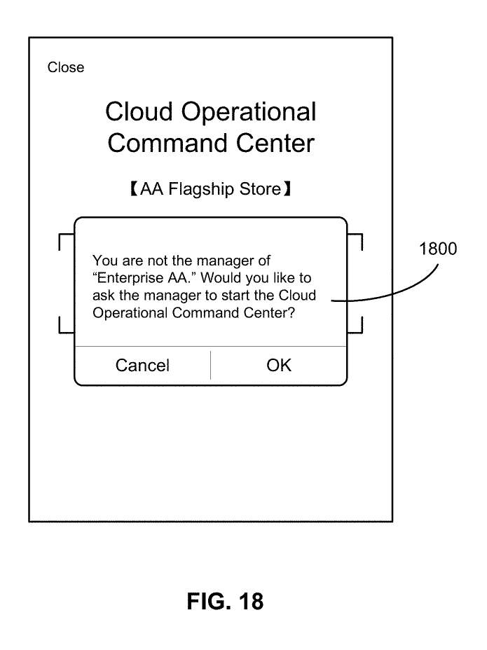

FIG. 18 is a diagram of an example messaging application interface for a no authorization prompt. Assume that user A selected Enterprise AA at organization binding interface 1500 shown in FIG. 15. That is, user A would like to bind “AA Flagship Store” and Enterprise AA to each other. In this case, the Enterprise WeChat client application or the Enterprise WeChat server needs to confirm that user A has management authority over Enterprise AA. If user A does not have management authority over Enterprise AA, the Enterprise WeChat client may display no authorization prompt interface 1800 shown in FIG. 18 and ask if user A would like to make a request to the Enterprise AA manager by selecting the “OK” option so that “AA Flagship Store” and Enterprise AA will be bound to each other after the manager approves.

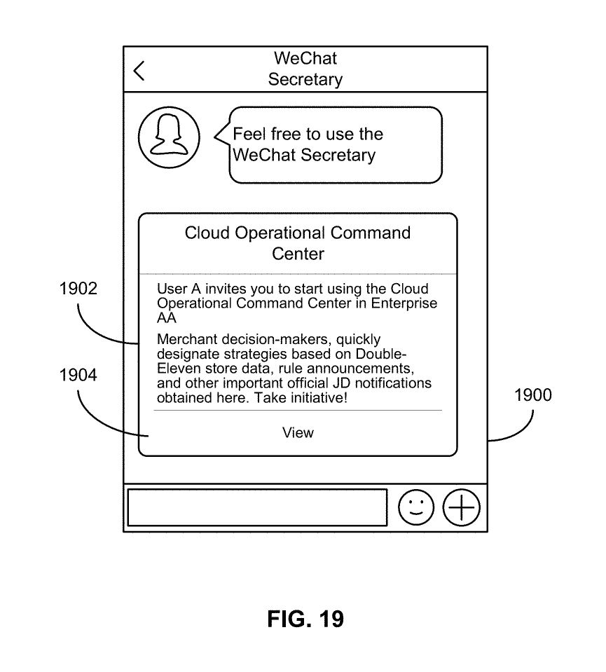

FIG. 19 is a diagram of an example messaging application interface for a user associated with the manager/administrator role with respect to the store. As shown in FIG. 19, when user A selects the “OK” option in no authorization prompt interface 1800 shown in FIG. 18, authorization request message 1902 may be received in system notification interface 1900 corresponding to the Enterprise AA manager. General information (e.g., “User A requests to start using the Cloud Operational Command Center in Enterprise AA”) concerning the authorization request may be displayed in system notification interface 1900 to inform Enterprise AA manager user why he or she is being shown this interface. To view related content, the manager user may switch to detailed browsing interface 2000 concerning the authorization request by selecting viewing option 1904 in authorization request message 1902 of FIG. 19.

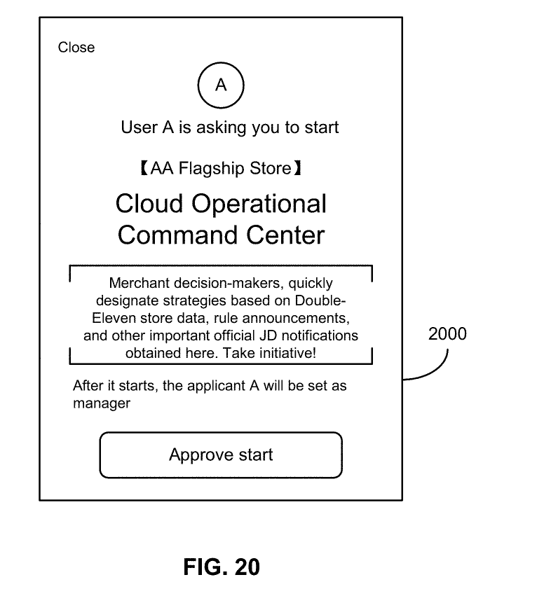

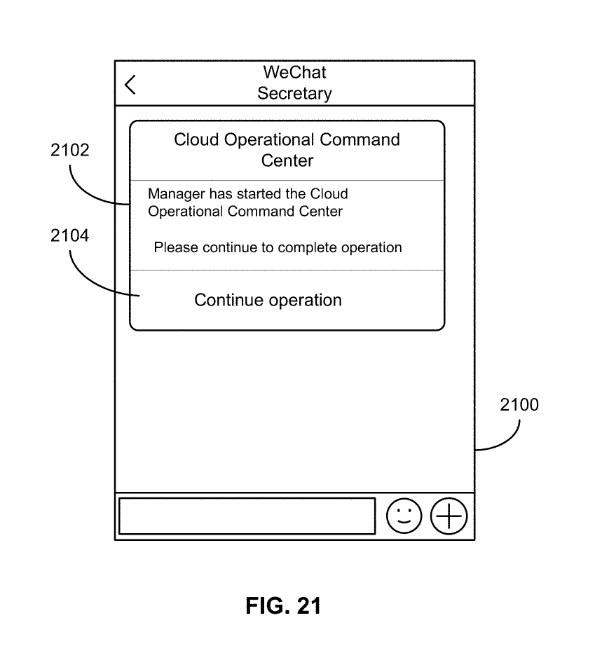

FIG. 20 is a diagram of an example messaging application interface for the user associated with the manager/administrator role with respect to the store. After the manager selects the “Approve start” option in browsing interface 2000, user A, who is the requester of the binding relationship, may receive corresponding successful request notification 2102 (indicating approval by the Enterprise AA manager) in system notification interface 2100 of FIG. 21 of the Enterprise WeChat client application. Once the manager user selects the “Approve start” button, the “AA Flagship Store” and Enterprise AA will be bound together. After selecting “continue operation” option 2104 in successful request notification 2102, user A can begin the subsequent processing flow.

In some embodiments, one organization/distribution group of the messaging service can bind to one or more online stores at the transaction platform. To give an example, Enterprise AA operates a total of three online stores at the transaction platform (specifically, “AA Flagship Store,” “AA Flagship Branch Store 1,” and “AA Flagship Branch Store 2”). In some embodiments, the three stores operated by Enterprise AA can be bound to the same distribution group, which is the equivalent of causing these stores to participate in a unified “Cloud Operational Command Center” in order to achieve unified management over these stores. In another example, the three stores operated by Enterprise AA can be bound separately to three different distribution groups at the transaction platform, which is the equivalent of causing these stores to separately participate in three independent “Cloud Operational Command Centers” in order to realize separate management of these three stores.

When the three stores are separately bound to three different distribution groups, each store can receive the same group communication messages, or they can separately receive different distribution group communication messages. For example, the distribution group bound to “AA Flagship Store,” which is the head store, can receive all information relating to all stores, but the distribution group bound to “AA Flagship Branch Store 1,” which is a branch store, only receives information relating to “AA Flagship Branch Store 1.”

In some embodiments, if three stores are bound to a single distribution group, the staff of each store can view all group communication messages within the distribution group and thus view information relating to all the stores. In some embodiments, different authorizations are granted to the staff members of each store and group communication messages are classified. As a result, the staff members at each store will view different group communication messages within the distribution group. For example, the staff members of “AA Flagship Store” can view all group communication messages pertaining to all three stores, while the staff members at “AA Flagship Branch Store 1” can only view group communication messages that concern their own store, “AA Flagship Branch Store 1.”

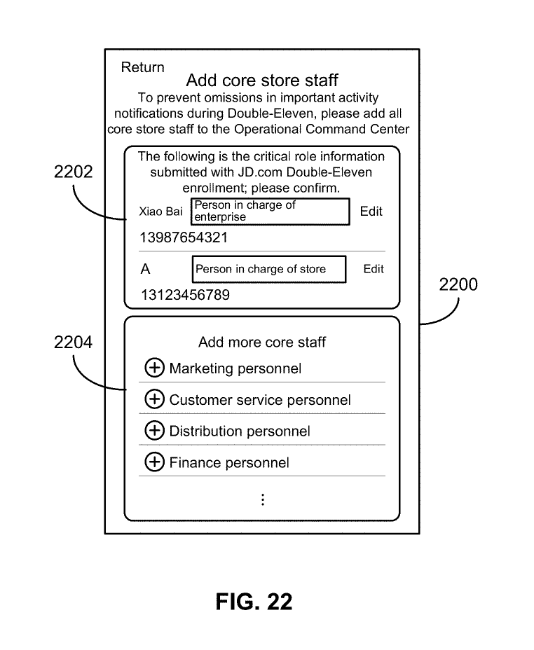

FIG. 22 is a diagram of an example messaging application interface for adding information associated with staff members of a store at the messaging service. As shown in FIG. 22, user A can add core store staff member to the “AA Flagship Store” through core staffing interface 2200. Examples of staff members include the person in charge of the “AA Flagship Store” enterprise, the person in charge of the store, and other decision-making personnel. Other examples include marketing personnel, customer service personnel, distribution personnel, finance personnel, and other executive personnel. Adding core store staff to the “AA Flagship Store” has effects in several areas.

For example, when “AA Flagship Store” and Enterprise AA are bound together, the staff members of “AA Flagship Store” can use the distribution group corresponding to Enterprise AA and promptly learn of JD.com-generated information relating to “AA Flagship Store.” Therefore, it is possible, through core staffing interface 2200 shown in FIG. 22, to ensure that all core staff members of “AA Flagship Store” are added to the distribution group without exception. In particular, functions or job information such as “Person in charge of enterprise,” “Person in charge of store,” “Marketing personnel,” “Customer service personnel,” “Distribution personnel,” and “Finance personnel” are used to describe each member of the store's core staff in core staffing interface 2200 (shown in FIG. 22). This helps user A to proceed according to actual functions or job needs and to avoid omissions.

After “AA Flagship Store” and Enterprise AA are bound together, in some embodiments, all the members of Enterprise AA are added as members to the distribution group. However, the staff of “AA Flagship Store” and the members of AA Enterprise often may not overlap entirely. Therefore, one can use core staffing interface 2200 shown in FIG. 22 to confirm that all the staff or core personnel of “AA Flagship Store” can be added to the distribution group.

In addition, core staffing interface 2200 shown in FIG. 22 can also be used to label and classify staff of “AA Flagship Store.” For example, “Xiao Bai” is designated as the “person in charge of the enterprise,” and user A is designated as the “person in charge of the store.” As shown in core staffing interface 2200, it is also possible to designate other group members as other types of core store staff such as “marketing personnel,” “customer service personnel,” “distribution personnel,” and “finance personnel.” Based on the results of labeling and classifying staff, in some embodiments, the messaging service (Enterprise WeChat) can add notifications or call outs to a particular staff member whose position is identified or relevant to a group message or a store-related update that is pushed to the distribution group. For example, when there is a group message or a store-related update about the “person in charge of the store,” the Enterprise WeChat server may add an alerting message for user A to the information. For example, an “@A” can be added to the information to enable the Enterprise WeChat client running on the user's device to execute a message alert specifically for user A. To give another example, an alerting message about the information may be sent to user A as an instant messaging communication message, a text message, or an automated telephone call. By sending an alerting message/an additional notification to user A for a communication that is received by the distribution group and that pertains specifically to user A, the likelihood that user A will see the communication and take action is improved.

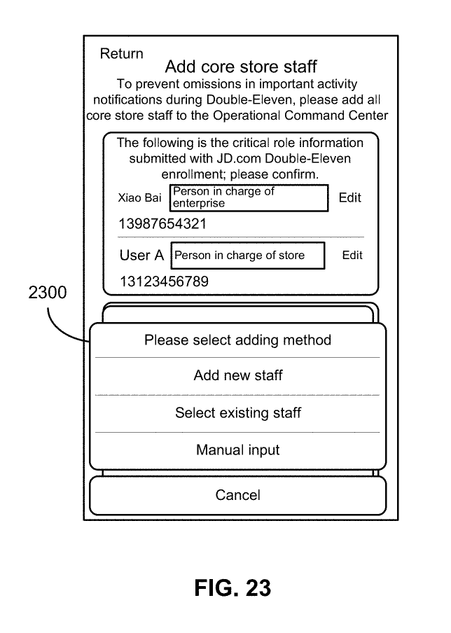

FIG. 23 is a diagram of an example messaging application interface for adding a core staff member. As shown in FIG. 23, it is assumed that user A selected an add operation for “Marketing personnel” (e.g., selected the “+” symbol to the left of “Marketing personnel” in FIG. 22). The enterprise WeChat client application may display adding method selection interface 2300 so that user A may select the adding method that they prefer. When the user that is to be added is already a member of the distribution group, user A may select the “Select existing staff” option and make a selection within the distribution group. When the user that is to be added does not already belong to the distribution group, or if user A does not wish to execute adding operations through the distribution group, user A may select the “Add new staff” option to select those contacts from user A's contact directory on the Enterprise WeChat client or from the contact directory stored locally on the device that user A wishes to add as “Marketing personnel.” Or user A may select the “Manual input” option to manually input the names, phone numbers, and other such user information of users that they wish to add as “marketing personnel.”

In some embodiments, core staffing interface 2200 shown in FIG. 22 may comprise first presentation area 2202 and second presentation area 2204. For example, transaction platform JD.com may obtain user information about some core store staff, e.g., “person in charge of enterprise” and “person in charge of store” associated with “AA Flagship Store” from user A in advance. As a result, store personnel information that is already stored by and then obtained from JD.com is presented at first presentation area 2202. As for core store staff not yet designated by user A on JD.com, second presentation area 2204 comprises an interface through which such personnel, e.g., “marketing personnel,” “customer service personnel,” “distribution personnel,” and “finance personnel,” may be input by user A.

In some embodiments, with regard to critical positions such as “person in charge of enterprise” and “person in charge of store” that are obtained from JD.com and presented at first presentation area 2202, the Enterprise WeChat client application can provide user A with authority to make modifications concerning the corresponding core store staff, e.g., authority to modify the telephone number of the user “Xiao Bai.” However, in some embodiments, user A is not allowed to perform deletion operations on information related to core store staff members (e.g., that is originally obtained from JD.com).

In some embodiments, the Enterprise WeChat client application may provide user A with the authority to modify or delete core store staff corresponding to ordinary positions in second presentation area 2204, such as “marketing personnel,” “customer service personnel,” “distribution personnel,” and “finance personnel.”

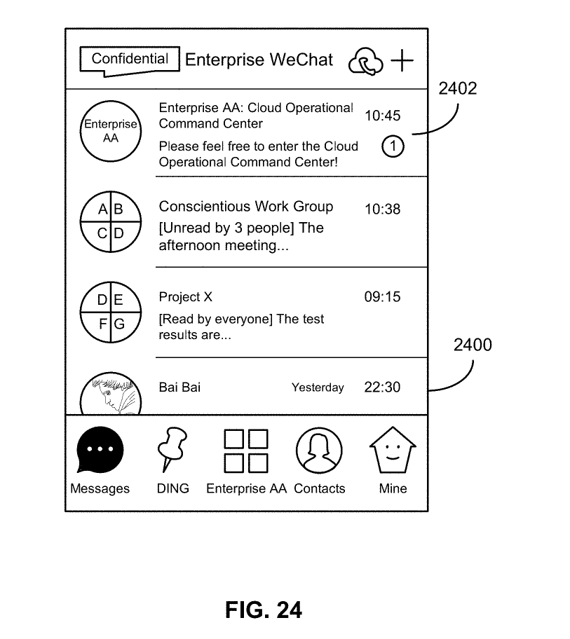

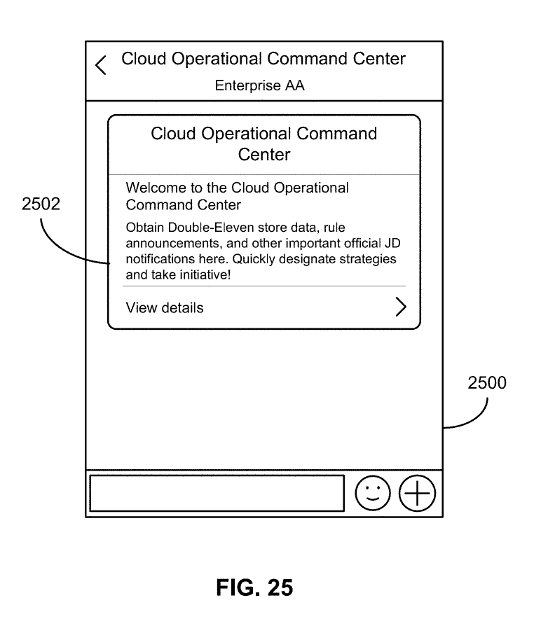

FIG. 24 is a diagram of a messaging application interface for a chat list. Chat list interface 2400 is presented to user A and includes portals to various chats that user A has with other individual users or groups of users of Enterprise WeChat. Chat list interface 2400 may display a chat interface portal 2402 corresponding to the appropriate group chat for the distribution group corresponding to Enterprise AA. User A can obtain unread message alerts for the distribution group through chat interface portal 2402 and can switch to chat interface 2500 shown in FIG. 25 by selecting chat interface portal 2402.

In some embodiments, when a server associated with implementing JD.com generates update information relating to “AA Flagship Store,” the server is configured to send the update information to the Enterprise WeChat server, and the Enterprise WeChat server may push it to the “Enterprise AA” distribution group, with the result that distribution group members (e.g., the staff members of “AA Flagship Store”) may receive and view the update information content. For example, when the Enterprise WeChat client application that user A is logged into receives a piece of information relating to “AA Flagship Store” that was generated by the server associated with implementing JD.com, the notification identifier “0” may be displayed in chat interface portal 2402 shown in FIG. 24. By selecting chat interface portal 2402, user A may enter chat interface 2500 shown in FIG. 25 in order to view communication message 2502 that was associated with the notification identifier “0.” Communication message 2502 includes the update that was received from JD.com with respect to “AA Flagship Store.”

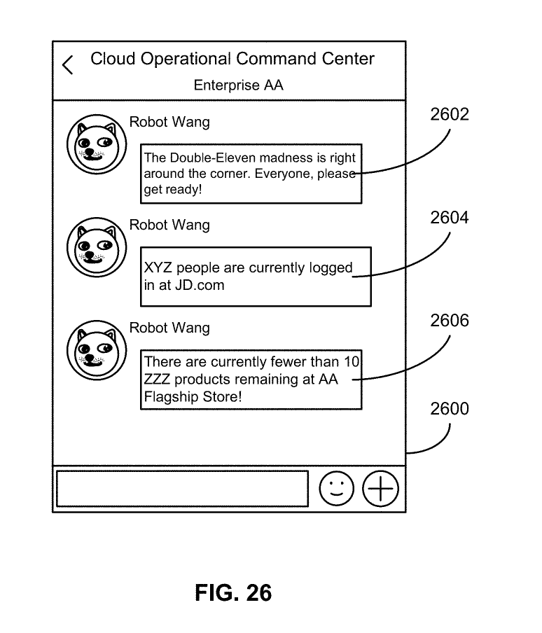

There could be various types of information relating to “AA Flagship Store” that are generated by JD.com. For example, in chat interface 2600 shown in FIG. 26, the information presented in communication message 2602 is official notifications from JD.com (e.g., an announcement issued by the transaction platform of JD.com). The information presented in communication message 2604 is the total number of people logged into JD.com (data on the entire network transaction platform of JD.com; in other examples, statistical data on a portion of the transactions in the network transaction platform of JD.com may be used). The information presented in communication message 2606 is the quantity of remaining products ZZZ in “AA Flagship Store” (statistical data on a portion of the store transactions of “AA Flagship Store”; in another example, statistical data on all store transactions of “AA Flagship Store” may be used). In the example of FIG. 26, each update message that is received from JD.com is presented as a message that is associated with “Robot Wang,” a chatbot that is not necessarily a user of the distribution group associated with Enterprise AA but rather a default chatbot that is presented as the sender of updates from JD.com.

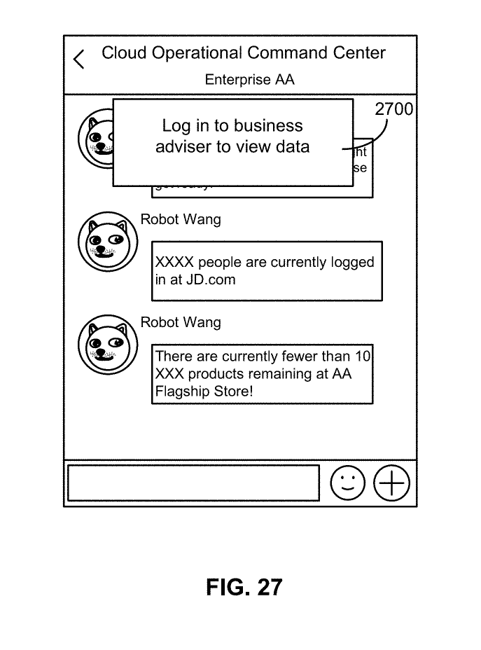

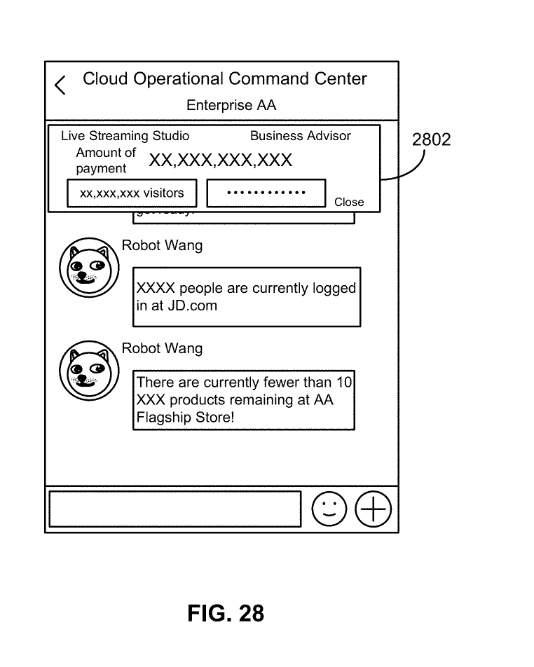

FIGS. 27 and 28 are diagrams of example floating display windows for presenting application functions in a chat interface at a messaging application. User A may assign related application functions to the distribution group “Enterprise AA.” To take the application function “Business Advisor” as an example, presentation window 2700 for the application function “Business Advisor” may be presented in the chat interface corresponding to the distribution group “Enterprise AA.”

In some embodiments, the application function “Business Advisor” may be a micro-application function, or it may be a mini-program function. Or the application function “Business Advisor” may be an original, built-in application function, or it may take some other form.

In some embodiments, when a user selection of presentation window 2700 that is shown in FIG. 27 is detected, the application function “Business Advisor” can be logged in. Thus, in the embodiment shown in FIG. 28, the application function “Business Advisor” can present obtained function data (e.g., the function data can be obtained from a WeChat server) in presentation window 2700 for viewing by user A. Similarly, other group members of the distribution group “Enterprise AA” may open the application function “Business Advisor” in their respective Enterprise WeChat clients in order to view function data provided by the application function “Business Advisor.”

In some embodiments, the function data presented by the application function “Business Advisor” may include any data relating to the transaction platform of JD.com as a whole or specifically to “AA Flagship Store.” For example, the function data in one implementation may include Big Board trading data about the transaction platform of JD.com, i.e., disclosable data about the entire platform within a specific time interval, such as total sales volume of the entire transaction platform, total number of browsing users, and total number of purchasing users. In another implementation, the function data may comprise the store transaction data of “AA Flagship Store,” i.e., the store's internal data (such as, for example, the total sales volume, the number of browsing users, the number of purchasing users, and the remainder quantity of each product) which will not be disclosed on the entire platform. Function data to be presented in an application function such as “Business Advisor” may be queried by a server associated with Enterprise WeChat from the server associated with JD.com.

In the example shown in FIG. 27, the operation of logging in the application function “Business Advisor” is not needed. For example, in some embodiments where login is not required, the application function “Business Advisor” directly presents obtained function data in, for example, presentation window 2800 shown in FIG. 28, thereby skipping the presentation of presentation window 2700 that invites the users to log in to “Business Advisor.”

In some embodiments, presentation window 2700 may present over the chat interface shown in FIGS. 27 and 28 in a manner that floats over the chat interfaces. As a result, when user A browses communication messages displayed in the chat interface, the display position of presentation window 2700 on the screen of the device will not be affected even if user A scrolls up and down on the chat interface. The purpose of the above is to ensure that user A may view presentation window 2700 and the function data it displays at any time, regardless of which portion of the chat interface is being presented.

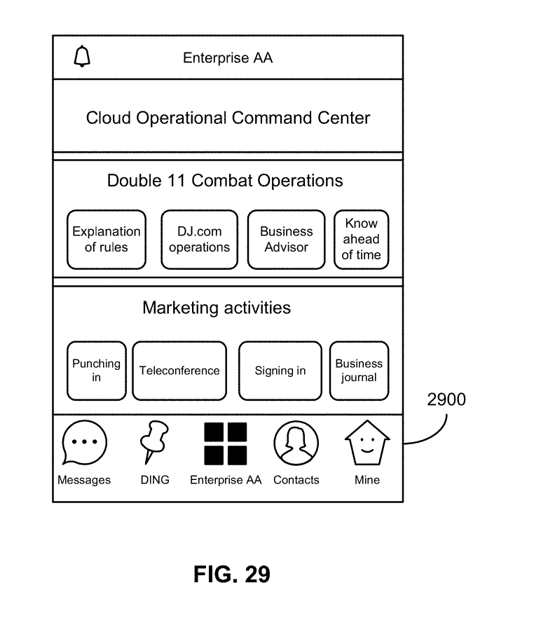

FIG. 29 is a diagram of an example messaging application interface for an organization. To take as an example chat list interface 2400 shown in FIG. 24, when the Enterprise WeChat client application detects that the “Enterprise AA” icon in the bottom menu bar has been selected by user A, it may switch to presenting organization home page 2900 shown in FIG. 29. Organization home page 2900 corresponding to Enterprise AA includes start portals for multiple types of “Marketing activities” application functions, such as “Punching in,” “Teleconference,” “Signing in,” and “Business journal.” These portals are for implementing the corresponding application functions. After Enterprise AA and “AA Flagship Store” are bound together, organization home page 2900 for Enterprise AA may also include portals for starting “Double-11 combat”-type application functions. As mentioned above, “Double 11” refers to a promotional sales event and may therefore be associated with special application functions that are configured to handle the activities associated with the event. Examples include “Explanation of rules,” “JD.com operations,” “Business advisor,” “Know ahead of time,” and so on. These portals enable user A to quickly look up application functions associated with the “Cloud Operational Command Center” through organization home page 2900 and help to improve user A's operating efficiency.

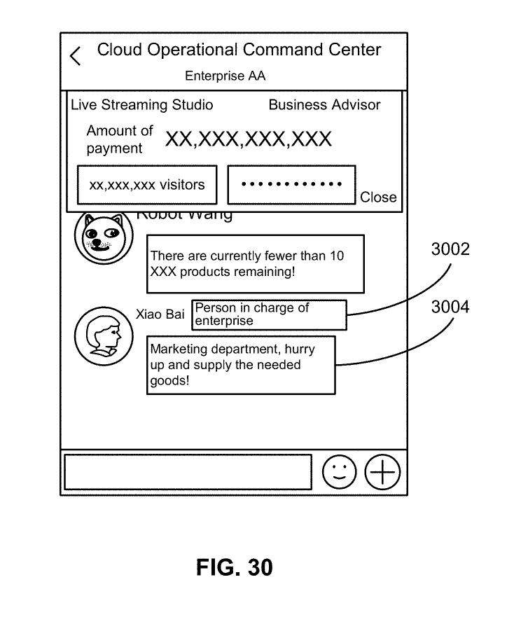

FIG. 30 is a diagram of an example messaging application interface for a user associated with the manager/administrator role at the store. As shown in FIG. 30, when user A receives communication message 3004 from the user “Xiao Bai” in the chat interface corresponding to the distribution group “Enterprise AA,” the management position of the user “Xiao Bai” in “AA Flagship Store” may be displayed near the user “Xiao Bai's” profile picture, name, and other user information. For example, the user “Xiao Bai” is labeled as the “person in charge of enterprise” in the form of job label 3002 in FIG. 30 so that group members who receive communication message 3004 may quickly recognize the store management position of the sender of the message.

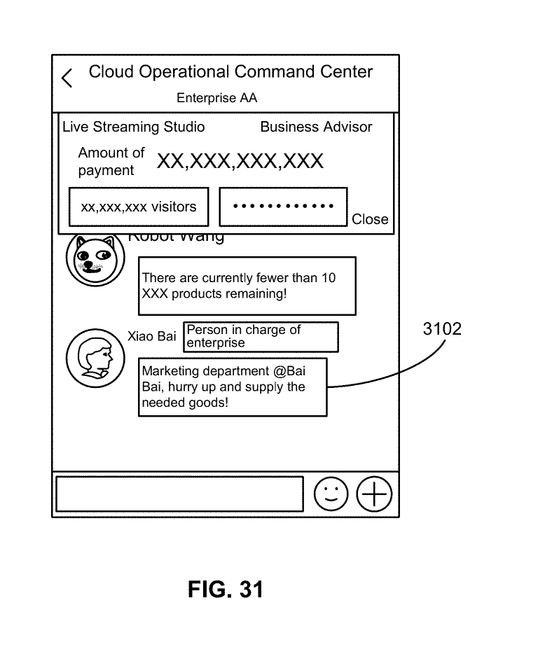

FIG. 31 is a diagram of an example messaging application interface for a distribution group member that is automatically being reminded. Let us assume that the original message content of the communication message sent by the user “Xiao Bai” is “Marketing department, hurry up and supply the needed goods!” Through the detection of the term “marketing department” in the original message content, for example, the Enterprise WeChat server can determine that the communication message relates to “marketing personnel” in “AA Flagship Store,” and that, according to data stored by Enterprise WeChat, the “marketing personnel” of “AA Flagship Store” is the user “Bai Bai.” Thus, the Enterprise WeChat server may give the user “Bai Bai” a reminder to ensure that they will view the communication message issued by the user “Xiao Bai.” For example, the Enterprise WeChat server may automatically add “@Bai Bai” to the original message content “Marketing department, hurry up and supply the needed goods!” The result is communication message 3102 received by the Enterprise WeChat client application used by the user “Bai Bai,” as shown in FIG. 31. Thus, the Enterprise WeChat client application used by the user “Bai Bai” may include a single reminder operation for the user “Bai Bai” based on inserting a callout of “@Bai Bai” into the original message sent by user “Xiao Bai.” Other users of the distribution group that are not part of the “marketing personnel” of “AA Flagship Store” may only view original communication message 3004 of FIG. 30 since their positions with respect to the store are not detected by the Enterprise WeChat server in the original message.

To give another example, the Enterprise WeChat server need not edit the communication message issued by the user “Xiao Bai,” but rather issue a separate alerting message to the user “Bai Bai.” The alerting message may contain the original message content of the communication message. The alerting message may be sent in a form that is different from the form of the original communication message, e.g., as a text message or a telephone call. As a result, the user “Bai Bai” may obtain a prompt in a different way than that of the original communication message, thus significantly increasing the likelihood that the user will learn of the communication message.

As described above, by implementing cross-platform function operations between a transaction platform and a messaging service, staff members of a store are enabled to promptly learn of store-related information on the transaction platform through distribution groups created on the messaging service and are thus able to efficiently formulate and issue strategies in response. At the same time, with regard to the network transaction platform, the gathering of store staff members into distribution groups on the messaging service makes it easier to centrally manage the staff members of each store and helps to ensure that relevant information is promptly announced and efficiently transmitted to such personnel.

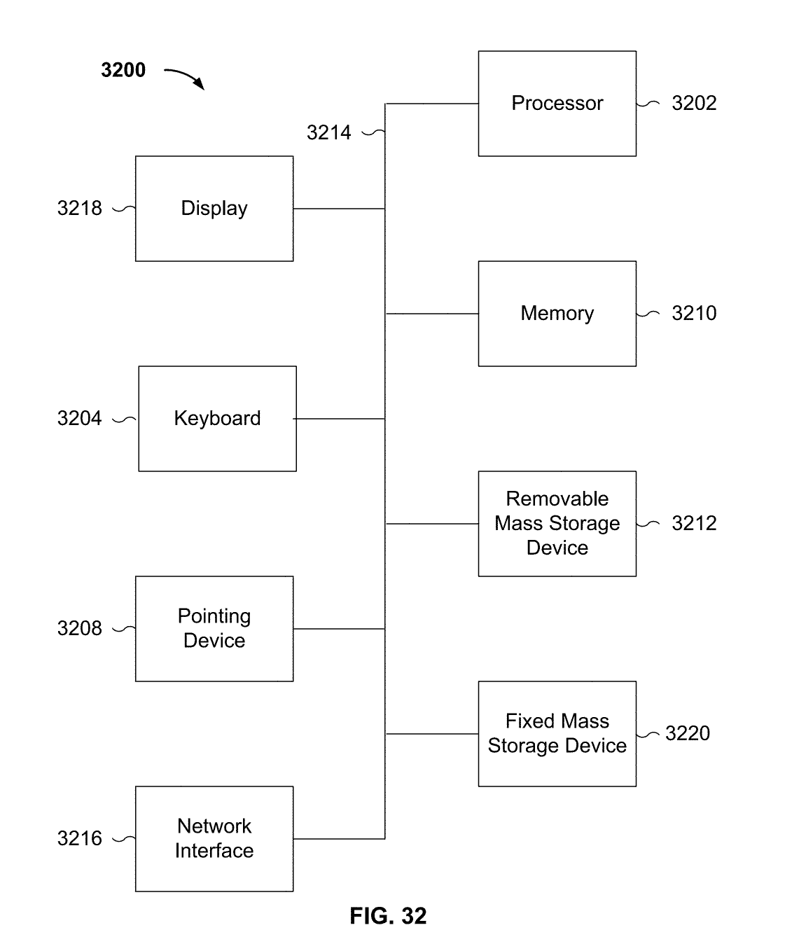

FIG. 32 is a functional diagram illustrating an embodiment of a programmed computer system for sending updates associated with a transaction platform to a distribution group of users associated with a messaging service. As will be apparent, other computer system architectures and configurations can be used to send updates associated with a transaction platform to a distribution group of users associated with a messaging service. Computer system 3200, which includes various subsystems as described below, includes at least one microprocessor subsystem (also referred to as a processor or a central processing unit (CPU)) 3202. For example, processor 3202 can be implemented by a single-chip processor or by multiple processors. In some embodiments, processor 3202 is a general purpose digital processor that controls the operation of the computer system 3200. Using instructions retrieved from memory 3210, the processor 3202 controls the reception and manipulation of input data, and the output and display of data on output devices (e.g., display 3218).

Processor 3202 is coupled bi-directionally with memory 3210, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 3202. Also as is well known in the art, primary storage typically includes basic operating instructions, program code, data, and objects used by the processor 3202 to perform its functions (e.g., programmed instructions). For example, memory 3210 can include any suitable computer readable storage media, described below, depending on whether, for example, data access needs to be bi-directional or uni-directional. For example, processor 3202 can also directly and very rapidly retrieve and store frequently needed data in a cache memory (not shown).

A removable mass storage device 3212 provides additional data storage capacity for the computer system 3200 and is coupled either bi-directionally (read/write) or uni-directionally (read only) to processor 3202. For example, storage 3212 can also include computer readable media such as magnetic tape, flash memory, PC-CARDS, portable mass storage devices, holographic storage devices, and other storage devices. A fixed mass storage 3220 can also, for example, provide additional data storage capacity. The most common example of fixed mass storage 3220 is a hard disk drive. Mass storages 3212, 3220 generally store additional programming instructions, data, and the like that typically are not in active use by the processor 3202. It will be appreciated that the information retained within mass storages 3212 and 3220 can be incorporated, if needed, in standard fashion as part of memory 3210 (e.g., RAM) as virtual memory.

In addition to providing processor 3202 access to storage subsystems, bus 3214 can also be used to provide access to other subsystems and devices. As shown, these can include a display 3218, a network interface 3216, a keyboard 3204, and a pointing device 3208, as well as an auxiliary input/output device interface, a sound card, speakers, and other subsystems as needed. For example, the pointing device 3208 can be a mouse, stylus, track ball, or tablet, and is useful for interacting with a graphical user interface.

The network interface 3216 allows processor 3202 to be coupled to another computer, computer network, or telecommunications network using a network connection as shown. For example, through the network interface 3216, the processor 3202 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 3202 can be used to connect the computer system 3200 to an external network and transfer data according to standard protocols. For example, various process embodiments disclosed herein can be executed on processor 3202, or can be performed across a network such as the Internet, intranet networks, or local area networks, in conjunction with a remote processor that shares a portion of the processing. Additional mass storage devices (not shown) can also be connected to processor 3202 through network interface 3216.

An auxiliary 110 device interface (not shown) can be used in conjunction with computer system 3200. The auxiliary 110 device interface can include general and customized interfaces that allow the processor 3202 to send and, more typically, receive data from other devices such as microphones, touch-sensitive displays, transducer card readers, tape readers, voice or handwriting recognizers, biometrics readers, cameras, portable mass storage devices, and other computers.

For example, computer system 3200 may comprise a smart phone or a computer. For example, memory 3210 is configured to store program instructions, and processor 3202, coupled to memory 3210, is configured to read the program instructions stored by memory 3210 and, in response, execute steps described in process 200 of FIG. 2, process 300 of FIG. 3, process 400 of FIG. 4, process 500 of FIG. 5, process 600 of FIG. 6, process 700 of FIG. 7, process 800 of FIG. 8, and process 900 of FIG. 9.

The systems, means, modules, or units illustrated by the above embodiments specifically may be implemented by computer chips or entities or by products having certain functions. A typical implementing device is a computer. The particular form a computer may take may be a personal computer, laptop computer, cellular phone, camera phone, smart phone, personal digital assistant, media player, navigation device, email receiving device, game console, tablet computer, wearable device, or a combination of any of these devices.

In a typical configuration, a computer comprises one or more processors (CPUs), input/output ports, network interfaces, and memory.

Memory may include the following forms in computer-readable media: volatile memory, random access memory (RAM), and/or non-volatile memory, e.g., read-only memory (ROM) or flash RAM. Memory is an example of a computer-readable medium.

Computer-readable media, including permanent and non-permanent and removable and non-removable media, may achieve information storage by any method or technology. The information may be computer-readable instructions, data structures, program modules, or other data. Examples of computer storage media include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk-read only memory (CD-ROM), digital versatile disk (DVD) or other optical storage, cassette tapes, magnetic tape and disk storage or other magnetic storage devices, or any other non-transmitting media that may be used to store computer-accessible information. In accordance with the definitions in this document, computer-readable media do not include transitory computer-readable media (transitory media) such as modulated data signals and carrier waves.

Please also note that the term “comprise” or “contain” or any of their variants are to be taken in their non-exclusive sense. Thus, processes, methods, merchandise, or devices that comprise a series of elements not only comprise those elements, but also comprise other elements that have not been explicitly listed or elements that are intrinsic to such processes, methods, merchandise, or devices. In the absence of further limitations, elements that are limited by the phrase “comprises a(n) . . . ” do not exclude the existence of additional identical elements in processes, methods, merchandise, or devices that comprise the elements.

Specific embodiments of this specification were described above. Other embodiments fall within the scope of the attached claims. In some situations, the actions or steps recorded in the claims may be executed according to sequences that differ from those in the embodiments, yet the expected result may still be achieved. In addition, the processes depicted in the drawings do not necessarily require the shown specific sequences or continuous sequences in order that the expected results be realized. In some implementations, multi-task processing and parallel processing may also be permissible or may be beneficial.

The terms used in one or more embodiments of this specification merely serve to describe specific embodiments and are not intended to restrict one or more embodiments of this specification. “A,” “the,” or “this” as used in their singular form in one or more embodiments of this specification and the claims also are intended to encompass the plural form, unless otherwise clearly indicated by the context. It is also important to understand that the term “and/or” as used herein refers to and encompasses any or all possible combinations of one or more inter-related listed items.

It is important to understand that, though the terms “first,” “second,” and “third” may be employed in one or more embodiments of this specification to describe various pieces of information, this information is not limited by these terms. These terms merely serve to differentiate between pieces of information of the same type. For example, without departing from the scope of one or more embodiments of this specification, “first information” may be called “second information,” and, similarly, “second information” may be called “first information.” Depending on context, the word “if” when used herein may be interpreted as “when” or “upon” or “in response to.”

The preferred embodiments of one or more embodiments of this specification that are described above are merely that and do not limit one or more embodiments of this specification. Any modification, equivalent substitution, or improvement that is made in keeping with the spirit and principles of one or more embodiments of this specification shall be included within the protective scope of one or more embodiments of this specification.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive an indication of an update associated with a store associated with a transaction platform from a server associated with the transaction platform;
in response to the indication, identify a distribution group of one or more users associated with a messaging service and wherein the distribution group has a binding relationship to the store;
determine respective one or more devices corresponding to the one or more users to of the distribution group; and
send the update to the respective one or more devices, wherein the update is configured to be displayed within a respective messaging application executing at each of the respective one or more devices; and
a memory coupled to the processor and configured to provide the processor with instructions.

2. The system of claim 1, wherein the processor is further configured to:
receive profile information associated with an organization to be associated with the messaging service;
receive identifying information associated with the one or more users to be included in the distribution group to be associated with the organization; and
send to storage the profile information associated with the organization and the identifying information associated with the one or more users to be included in the distribution group.

3. The system of claim 2, wherein the one or more users includes a first user and wherein the identifying information associated with the one or more users to be included in the distribution group to be associated with the organization includes one or more of the following: device information associated with the first user, a position with respect to the organization associated with the first user, a position with respect to the store associated with the first user, and contact information associated with the first user.

4. The system of claim 1, wherein the processor is further configured to:
receive a binding request from a messaging application that is executing at a device, wherein the binding request includes one or more of the following: identifying information associated with the transaction platform, identifying information associated with the distribution group associated with the messaging service, and identifying information associated with a user that is signed into the messaging application;
send the binding request to the server associated with the transaction platform;
receive a response from the server associated with the transaction platform, wherein the response indicates whether the user is authorized to bind the distribution group to the store; and
determine, at least in part on the response, whether to enable updates associated with the store to be pushed to the respective one or more devices corresponding to the one or more users of the distribution group.

5. The system of claim 4, wherein in the event that the response indicates that the user is authorized to bind the distribution group to the store, the updates associated with the store are enabled to be pushed to the respective one or more devices corresponding to the one or more is users of the distribution group.

6. The system of claim 4, wherein in the event that the response indicates that the user is not authorized to bind the distribution group to the store, the updates associated with the store are not enabled to be pushed to the respective one or more devices corresponding to the one or more users of the distribution group.

7. The system of claim 4, wherein in the event that the response indicates that the user is not authorized to bind the distribution group to the store, the response further includes identifying information with another user for which stored data indicates that the other user is authorized to bind the distribution group to the store, wherein the processor is further configured to send a prompt to a device associated with the other user using the identifying information with another user, wherein the prompt includes a control associated with approving binding the distribution group to the store.

8. The system of claim 1, wherein the processor is further configured to:
receive a message sent to the distribution group by a first user that is included in the distribution group;
determine that the message includes a reference to a position with respect to the store;
use stored data to determine that the position with respect to the store is associated with a second user that is included in the distribution group;
send the message to the respective one or more devices corresponding to the one or more users of the distribution group; and
send an alert with respect to the message to a device corresponding to the second user.

9. The system of claim 1, wherein the update associated with the store comprises one or more of the following: an announcement message issued by the transaction platform, transaction activity data associated with the store, and transaction activity data associated with the transaction platform.

10. The system of claim 1, wherein the processor is further configured to:
receive a change in staff with respect to the store from the server associated with the transaction platform; and
add a new user or remove an existing user from the distribution group based at least in part on the received change.

11. A method, comprising:
receiving an indication of an update associated with a store associated with a transaction platform from a server associated with the transaction platform;
in response to the indication, identifying a distribution group of one or more users associated with a messaging service and wherein the distribution group has a binding relationship to the store;
determining respective one or more devices corresponding to the one or more users of the distribution group; and
sending the update to the respective one or more devices, wherein the update is configured to be displayed within a respective messaging application executing at each of the respective one or more devices.

12. The method of claim 11, further comprising:
receiving profile information associated with an organization to be associated with the messaging service;
receiving identifying information associated with the one or more users to be included in the distribution group to be associated with the organization; and
sending to storage the profile information associated with the organization and the identifying information associated with the one or more users to be included in the distribution group.

13. The method of claim 12, wherein the one or more users includes a first user and wherein the identifying information associated with the one or more users to be included in the distribution group to be associated with the organization includes one or more of the following:
device information associated with the first user, a position with respect to the organization associated with the first user, a position with respect to the store associated with the first user, and contact information associated with the first user.

14. The method of claim 11, further comprising:
receiving a binding request from a messaging application that is executing at a device, wherein the binding request includes one or more of the following: identifying information associated with the transaction platform, identifying information associated with the distribution group associated with the messaging service, and identifying information associated with a user that is signed into the messaging application;
sending the binding request to the server associated with the transaction platform;
receiving a response from the server associated with the transaction platform, wherein the response indicates whether the user is authorized to bind the distribution group to the store; and
determining, at least in part on the response, whether to enable updates associated with the store to be pushed to the respective one or more devices corresponding to the one or more users of the distribution group.

15. The method of claim 14, wherein in the event that the response indicates that the user is authorized to bind the distribution group to the store, the updates associated with the store are enabled to be pushed to the respective one or more devices corresponding to the one or more users of the distribution group.

16. The method of claim 14, wherein in the event that the response indicates that the user is not authorized to bind the distribution group to the store, the updates associated with the store are not enabled to be pushed to the respective one or more devices corresponding to the one or more users of the distribution group.

17. The method of claim 14, wherein in the event that the response indicates that the user is not authorized to bind the distribution group to the store, the response further includes identifying information with another user for which stored data indicates that the other user is authorized to bind the distribution group to the store, the method further comprises sending a prompt to a device associated with the other user using the identifying information with another user, wherein the prompt includes a control associated with approving binding the distribution group to the store.

18. A system, comprising:
a processor configured to:
to receive an update associated with a store associated with a transaction platform; and
present the update at an interface of a messaging application, wherein the interface is associated with a distribution group associated with the store; and
a memory coupled to the processor and configured to provide the processor with instructions.

19. The system of claim 18, wherein the processor is further configured to present within the interface a message sent from a first user included in the distribution group to the distribution group.

20. The system of claim 18, wherein the processor is further configured to present within the interface information associated with a position associated with the first user included in the distribution group.
